(19) United States
(12) Patent Application Publication
(10) Pub. No.: US 2026/0301493 A1
(43) Pub. Date: Oct. 1, 2026

(54) ACCESS CONTROL

(71) Applicant: Resolution Products, LLC, St. Paul, MN (US)

(72) Inventors: Petre Tzvetkov, Sofia (BG); Dobrin Nedev, Sofia (BG); David J. Mayne, Eagan, MN (US)

(21) Appl. No.: 19/636,519

(22) Filed: Apr. 1, 2026

Related U.S. Application Data
(60) Provisional application No. 63/781,798, filed on Apr. 1, 2025.

(51) Int. Cl. G07C 9/00; H04W 12/06

(52) U.S. Cl. CPC G07C 9/00309; G07C 9/00571; H04W 12/06; G07C 2009/00769

(57) ABSTRACT

The subject matter of this specification can be embodied in, among other things, an access control system that includes an NFC tag configured to provide a data value, an access point having a lock, a controller configured to transmit instructions to change the state of the lock, where the controller includes a local wireless interface and a data repository storing authentication data for authorized users, and a mobile device that includes an NFC reader, a local wireless network interface, where the mobile device is configured to receive the data value from the NFC tag, interpret the data value, generate a wireless access request, and transmit the wireless access request to the controller over a local wireless network connection with the controller, where the controller is configured to evaluate the authentication data against the locally stored authentication data and send a control signal to the lock.

### CROSS REFERENCE TO RELATED APPLICATIONS

This application claims the priority benefit of U.S. Provisional Patent Application No. 63/781,798, filed Apr. 1, 2025, the entirety of which is incorporated herein by reference.

### TECHNICAL FIELD

This specification relates to electronic device communication, including electronic device communication in security and automation systems.

### BACKGROUND

Conventional electronic access control systems often rely on wired components, such as radio frequency (RF) identification (RFID) readers connected to centralized access control panels or servers, typically via dedicated local area networks within a building. These systems often require significant infrastructure installation, including wiring for power and data, which increases cost and deployment complexity. Furthermore, many conventional systems depend on continuous connectivity to a local server or a cloud-based service for authentication decisions and system management. This dependency can limit deployment in remote locations lacking robust network infrastructure or in high-security environments where external network connections are undesirable. Additionally, reliance on centralized controllers or constant cloud connectivity can introduce points of failure or latency in access decisions. Power outages can also disable traditional systems unless complex backup power solutions are implemented.

### SUMMARY

This specification relates to electronic device communication, including electronic device communication in security and automation systems.

In an example embodiment, an access control system includes a near field communication (NFC) tag configured to wirelessly provide a data value, an access point comprising a lock and a mechanism to control a state of the lock, a controller for the access point that is configured to transmit instructions to the access point to change the state of the lock, wherein the controller further includes a first local wireless network interface and a first data repository, where the first data repository is configured to locally store authentication data for authorized users, and a mobile device that includes an NFC reader, a second local wireless network interface, and a second data repository that stores authentication data for a corresponding user, where the mobile device is configured to receive, using the NFC reader, the data value from the NFC tag, interpret the data value received from the NFC tag, generate, based on the interpretation of the data value, a wireless access request, wherein the wireless access request includes the controller as a recipient and the authentication data, and transmit, using the second local wireless network interface, the wireless access request to the controller over a local wireless network connection with the controller, where the controller is configured to evaluate the authentication data received in the wireless access request received from the mobile device against the locally stored authentication data and, based on the evaluation, to send a control signal to the access point to modify a state of the lock.

Various embodiments can include some, all, or none of the following features. The access control system can include a cellular transceiver, and where the mobile device is further configured to determine that the transmission of the wireless access request to the controller over the local wireless network connection has failed, and transmit, using the cellular transceiver, a fallback access request to a remote cloud server over a cellular network. The controller can include a controller cellular transceiver, and wherein the controller is configured to receive an unlock command from the remote cloud server via the controller cellular transceiver based on an authentication of the fallback access request by the remote cloud server. The controller cellular transceiver can be configured to communicate using a Long-Term Evolution M (LTE-M) protocol. The controller can include a power interface configured to receive electrical power from at least one of a Power over Ethernet (PoE) connection or a Universal Serial Bus Type-C (USB-C) connection. The controller can be configured to utilize the USB-C connection as a backup power source in response to a power failure of the PoE connection. The locally stored authentication data of the controller can include a cached subset of global authentication data, where the cached subset corresponds to authorized users who have recently accessed the access point. The controller can be configured to determine that the authentication data received in the wireless access request from the mobile device is absent from the cached subset, and in response to determining the authentication data is absent, transmit a verification request to a remote cloud server to authenticate the mobile device against a global data repository of authorized user credentials. The controller can be further configured to update the cached subset of global authentication data stored in the data repository based on an authentication response received from the remote cloud server. The access control system can include a camera in communication with the controller, where the controller is configured to cause the camera to capture image data of a user associated with the mobile device in response to receiving the wireless access request. The controller can be configured to perform biometric facial recognition on the captured image data, and the control signal to modify the state of the lock can be further conditioned upon the biometric facial recognition matching an authorized user profile associated with the authentication data. The controller can include a cellular transceiver, and wherein the controller is configured to format the captured image data for transmission over a cellular network, and transmit an access log comprising the formatted image data to a remote cloud server via the cellular transceiver. The local wireless network interface of the controller and the local wireless network interface of the mobile device can be configured to communicate using a Bluetooth Low Energy (BLE) protocol. The controller can include an application programming interface (API) configured to synchronize an intrusion signal with captured video data and transmit a unified event record to a remote security monitoring system. The controller can be configured to operate in a stand-alone configuration independently of a local area network (LAN) associated with the access point.

In an example implementation, a method for controlling access to a secure location includes receiving, by a mobile device from a near field communication (NFC) tag, a data value, generating, by the mobile device based on the data value, a wireless access request having authentication data, transmitting, by the mobile device over a local wireless network connection, the wireless access request to a controller associated with an access point, evaluating, by the controller, the authentication data against locally stored authentication data, and modifying, by the controller, a state of a lock of the access point based on the evaluation.

Various implementations can include some, all, or none of the following features. The method can further include determining, by the mobile device, that the local wireless network connection to the controller has failed, and transmitting, by the mobile device over a cellular network, a fallback access request to a remote cloud server to authenticate the mobile device. The method can further include authenticating, by the remote cloud server, the fallback access request, transmitting, by the remote cloud server, an unlock command to the controller via a cellular transceiver of the controller, and modifying, by the controller, the state of the lock based on receiving the unlock command. The method can further include powering the controller via a Power over Ethernet (PoE) connection, and transitioning the controller to draw power from a USB-C power source in response to detecting a disruption in the PoE connection. The method can further include capturing, by a camera in communication with the controller, image data of a user attempting to access the access point, compressing, by the controller, the image data, and transmitting, by a cellular transceiver of the controller, an access log comprising the compressed image data to a remote cloud server.

In a first example, an access control system comprises a near field communication (NFC) tag configured to wirelessly provide a data value, an access point comprising a lock and a mechanism to control a state of the lock, a controller for the access point that is configured to transmit instructions to the access point to change the state of the lock, wherein the controller further includes a first local wireless network interface and a first data repository, wherein the first data repository is configured to locally store authentication data for authorized users, and a mobile device that includes an NFC reader, a second local wireless network interface, and a second data repository that stores authentication data for a corresponding user, wherein the mobile device is configured to receive, using the NFC reader, the data value from the NFC tag, interpret the data value received from the NFC tag, generate, based on the interpretation of the data value, a wireless access request, wherein the wireless access request includes the controller as a recipient and the authentication data, and transmit, using the second local wireless network interface, the wireless access request to the controller over a local wireless network connection with the controller, wherein the controller is configured to evaluate the authentication data received in the wireless access request received from the mobile device against the locally stored authentication data and, based on the evaluation, to send a control signal to the access point to modify a state of the lock.

In a second example, according to the access control system of example 1, the mobile device further comprises a cellular transceiver, and wherein the mobile device is further configured to determine that the transmission of the wireless access request to the controller over the local wireless network connection has failed, and transmit, using the cellular transceiver, a fallback access request to a remote cloud server over a cellular network.

In a third example, according to the access control system of example 1 or 2, the controller further comprises a controller cellular transceiver, and wherein the controller is configured to receive an unlock command from the remote cloud server via the controller cellular transceiver based on an authentication of the fallback access request by the remote cloud server.

In a fourth example, according to the access control system of any one of examples 1 to 3, the controller cellular transceiver is configured to communicate using a Long-Term Evolution M (LTE-M) protocol.

In a fifth example, according to the access control system of any one of examples 1 to 4, the controller further comprises a power interface configured to receive electrical power from at least one of a Power over Ethernet (PoE) connection or a Universal Serial Bus Type-C (USB-C) connection.

In a sixth example, according to the access control system of any one of example 1 to 5, the controller is configured to utilize the USB-C connection as a backup power source in response to a power failure of the PoE connection.

In a seventh example, according to the access control system of any one of examples 1 to 6, wherein the locally stored authentication data of the controller comprises a cached subset of global authentication data, wherein the cached subset corresponds to authorized users who have recently accessed the access point.

In an eighth example, according to the access control system of any one of examples 1 to 7, wherein the controller is further configured to determine that the authentication data received in the wireless access request from the mobile device is absent from the cached subset, and in response to determining the authentication data is absent, transmit a verification request to a remote cloud server to authenticate the mobile device against a global data repository of authorized user credentials.

In a ninth example, according to the access control system of any one of examples 1 to 8, wherein the controller is further configured to update the cached subset of global authentication data stored in the data repository based on an authentication response received from the remote cloud server.

In a tenth example, according to the access control system of any one of examples 1 to 9, further comprising a camera in communication with the controller, wherein the controller is configured to cause the camera to capture image data of a user associated with the mobile device in response to receiving the wireless access request.

In an eleventh example, according to the access control system of any one of examples 1 to 10, wherein the controller is configured to perform biometric facial recognition on the captured image data, and wherein the control signal to modify the state of the lock is further conditioned upon the biometric facial recognition matching an authorized user profile associated with the authentication data.

In a twelfth example, according to the access control system of any one of examples 1 to 10, wherein the controller further comprises a cellular transceiver, and wherein the controller is configured to format the captured image data for transmission over a cellular network, and transmit an access log comprising the formatted image data to a remote cloud server via the cellular transceiver.

In a thirteenth example, according to the access control system of any one of examples 1 to 12, wherein the local wireless network interface of the controller and the local wireless network interface of the mobile device are configured to communicate using a Bluetooth Low Energy (BLE) protocol.

In a fourteenth example, according to the access control system of any one of examples 1 to 13, wherein the controller further comprises an application programming interface (API) configured to synchronize an intrusion signal with captured video data and transmit a unified event record to a remote security monitoring system.

In a fifteenth example, according to the access control system of any one of examples 1 to 14, wherein the controller is configured to operate in a stand-alone configuration independently of a local area network (LAN) associated with the access point.

In a sixteenth example, a method for controlling access to a secure location comprises receiving, by a mobile device from a near field communication (NFC) tag, a data value, generating, by the mobile device based on the data value, a wireless access request comprising authentication data, transmitting, by the mobile device over a local wireless network connection, the wireless access request to a controller associated with an access point, evaluating, by the controller, the authentication data against locally stored authentication data, and modifying, by the controller, a state of a lock of the access point based on the evaluation.

In a seventeenth example, according to the method of example 16, the method further comprises determining, by the mobile device, that the local wireless network connection to the controller has failed, and transmitting, by the mobile device over a cellular network, a fallback access request to a remote cloud server to authenticate the mobile device.

In an eighteenth example, according to the method of example 16 or 17, the method further comprises authenticating, by the remote cloud server, the fallback access request, transmitting, by the remote cloud server, an unlock command to the controller via a cellular transceiver of the controller, and modifying, by the controller, the state of the lock based on receiving the unlock command.

In a nineteenth example, according to the method of any one of examples 16 to 18, the method further comprises powering the controller via a Power over Ethernet (PoE) connection, and transitioning the controller to draw power from a USB-C power source in response to detecting a disruption in the PoE connection.

In a twentieth example, according to the method of any one of examples 16 to 19, the method further comprising capturing, by a camera in communication with the controller, image data of a user attempting to access the access point, compressing, by the controller, the image data, and transmitting, by a cellular transceiver of the controller, an access log comprising the compressed image data to a remote cloud server.

The systems and techniques described herein may provide one or more of the following advantages. First, the system can reduce installation cost and complexity by reducing or minimizing wiring (e.g., using local RF and NFC for primary authentication and flexible power options like USB-C battery packs) and reducing or eliminating the need for dedicated local network infrastructure or centralized on-site controllers. Second, primary authentication can occur locally and quickly via direct device-to-device communication (e.g., BLE) without cloud latency, improving user experience. Third, the system can enhance security as primary access decisions do not rely on potentially vulnerable cloud connections. Fourth, network independence (e.g., optional cellular, no reliance on building Wi-Fi/Ethernet) can allow deployment in diverse environments, including remote or high-security locations. Fifth, flexible power options (PoE, USB-C, battery packs) can simplify installation and provide inherent backup power during outages. Sixth, cloud fallback can provide access continuity even if local RF communication is disrupted. Seventh, optional cloud connectivity can enable scalable, centralized management of credentials and logs across multiple devices and properties without local servers.

The details of one or more implementations are set forth in the accompanying drawings and the description below. Other features and advantages will be apparent from the description and drawings, and from the claims.

### BRIEF DESCRIPTION OF THE DRAWINGS

This specification relates to electronic device communication, including electronic device communication in security and automation systems.

FIG. 1 shows a schematic overview of an example mobile device-based access control system.

FIG. 1′ shows a conceptual use case for the example mobile device-based access control system of FIG. 1.

FIG. 2 is a block diagram of an example mobile device configured as part of the example mobile device-based access control system of FIG. 1

FIG. 3 is a flow diagram illustrating an example process for local access authentication.

FIG. 4 is a flow diagram illustrating an example process for cloud fallback authentication.

FIG. 5 is a flow diagram illustrating an example process for cloud synchronization.

FIG. 6 is a schematic diagram that shows an example of a computing system that may be used to implement the techniques described herein.

FIG. 7 is a block diagram illustrating an example hardware architecture for an access controller,

FIG. 8 is a table illustrating example specifications for the access controller architecture described in the present disclosure.

FIG. 9 illustrates an example physical access controller and a corresponding mobile application interface for the access control system described herein.

FIG. 10 is a comparison chart illustrating various features and configurations for a family of communicator devices and access controllers.

FIG. 11 illustrates example power configurations for an access controller managing an access point.

FIG. 12 is a schematic diagram illustrating example network routing logic for communicating with an access controller.

FIG. 13 is a schematic diagram illustrating an example communication architecture for an access control system.

FIG. 14 is a schematic diagram illustrating an example interaction scenario for initiating an access request utilizing a passive tag.

FIG. 15 is a schematic diagram illustrating an example credential synchronization process for a distributed access control system.

FIG. 16 is a schematic diagram illustrating an example logging architecture for a distributed access control system.

FIG. 17 is a schematic diagram illustrating an example integrated video and access logging architecture for a distributed access control system.

FIG. 18 is a schematic diagram illustrating an example multiuser access architecture for a distributed access control system.

FIG. 19 is a schematic diagram illustrating an example local video integration architecture for a distributed access control system.

FIG. 20 is a schematic diagram illustrating an example edge processing and cellular transmission architecture for a distributed access control system.

FIG. 21 is a schematic diagram illustrating an example integrated security and video architecture for a distributed access control system.

FIG. 22 is a schematic diagram illustrating an example video annotation and contextualization architecture for a distributed access control system.

FIG. 23 is a flow diagram of an example process for providing decentralized access control.

### DETAILED DESCRIPTION

In the following detailed description, numerous specific details are set forth by way of examples to provide a thorough understanding of the relevant teachings. However, it should be apparent to those skilled in the art that the present teachings may be practiced without such details. In other instances, well-known methods, procedures, components, and/or circuitry have been described at a relatively high level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

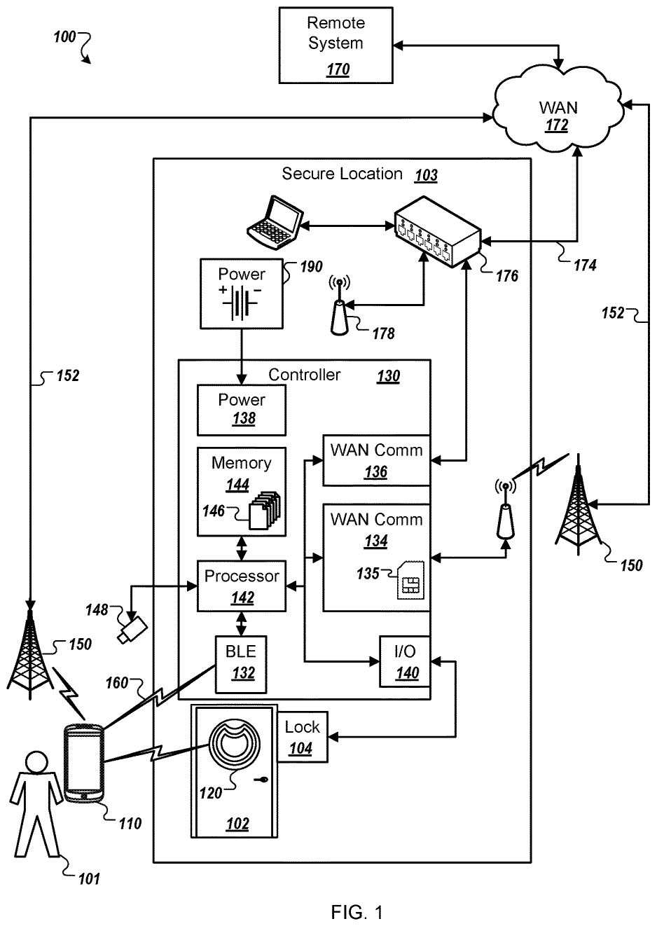

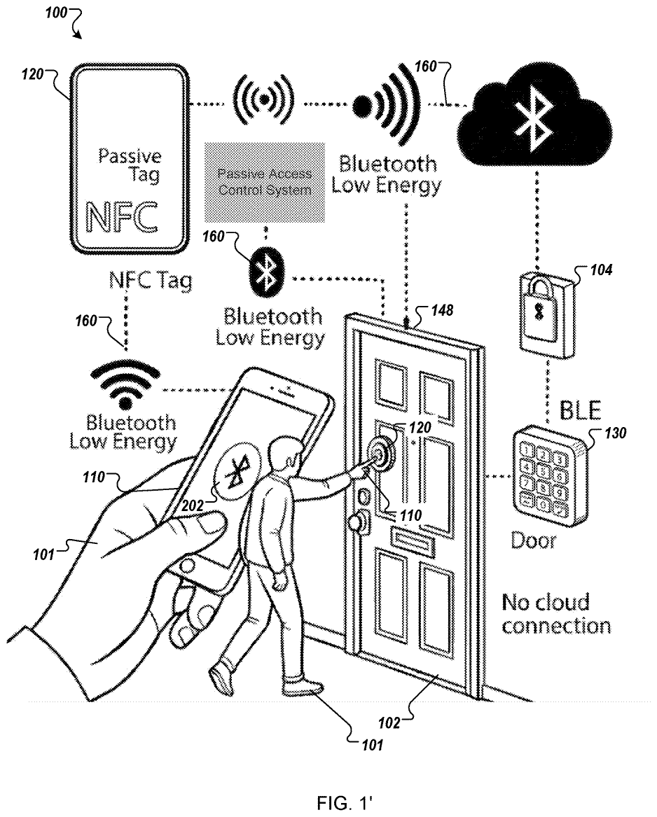

FIGS. 1 and 1′ show a schematic overview of an example mobile device-based access control system 100. The system is designed to provide secure and flexible access control for a secure location 103, such as a building, room, a safe, a window, a vehicle, or any other appropriate securable area or object, accessed via an access point 102 (e.g., a door) equipped with an electronic lock 104. The system 100 utilizes a mobile device 110 (e.g., smartphone) controlled by a user 101, a passive near field communications (NFC) tag 120 arranged on or proximal to the access point 102 (e.g., a door), and an access controller 130.

The passive NFC tag 120 is typically inexpensive and requires no power. The passive NFC tag 120 is placed near the access point 102 (e.g., on or near the door). The passive NFC tag 120 stores an identifier or other data that can be read by the mobile device 110 when brought into close proximity (typically a few centimeters) to the passive NFC tag 120.

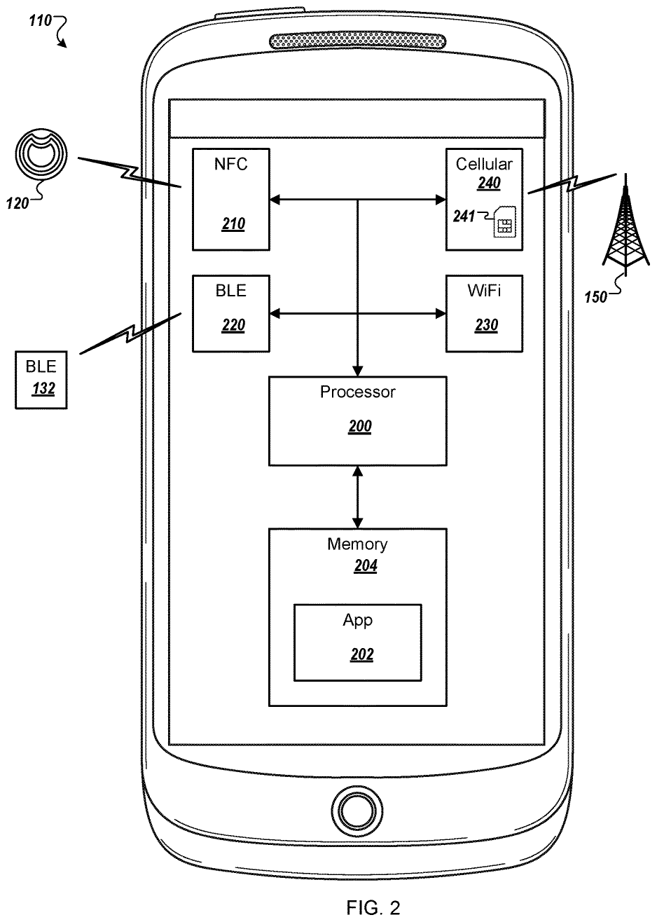

Referring briefly to FIG. 2, the mobile device 110 includes a processor 200 that is configured to execute a dedicated access control application 202 stored in a memory 204. The mobile device 110 includes an NFC reader 210 capable of reading the NFC tag 120, a local radio frequency (RF) transceiver 220 (e.g., a BLUETOOTH Low Energy, or BLE, radio), a network transceiver 230 (e.g., a Wi-Fi radio), and a cellular transceiver 240 having a SIM card 241 or eSIM (e.g., or dual or multiple SIMs/eSIMs) for communication over a cellular network 150.

Referring again to FIG. 1, the access controller 130 is installed near the access point 102. The access controller 130 includes a processor 142 and memory 144 for processing and storing a collection of access credentials 146. It also includes a local RF transceiver 132 (compatible with the mobile device's RF transceiver 220, e.g., BLE), a cellular transceiver 134 (e.g., Long Term Evolution M, or CAT-M, cellular technology module) having a SIM card 135 or an eSIM, a network interface 136 (e.g., Ethernet or Wi-Fi), a power interface 138, and a lock interface 140 configured to control the electronic lock 104. The lock interface 140 provides electrical signals (e.g., relay contacts, voltage outputs) to control the electronic lock 104 associated with the access point 102.

In some embodiments, the processor 142 can be an STM32G030K6 microcontroller. In some embodiments, the RF transceiver 132 can be an ESP32-WROVER-E microcontroller (e.g., having Wi-Fi and BLUETOOTH capabilities). In some embodiments, the cellular transceiver 134 can be a Telit ME310G1-WV cellular module (e.g., compatible with dual mode LTE CAT M1/NB2). In some embodiments, the access controller 130 can be configured to receive access requests from multiple local RF transceivers 132 (e.g., multiple BLE or RFID readers), and or can be configured to control multiple electronic locks 104 at multiple access points 102.

In an example local authentication scenario, a user approaches the access point 102 and taps the NFC tag 120 with their mobile device 110. The mobile device's NFC reader 210 reads data from the tag 120. The application 202 on the mobile device 110 stores or accesses authentication credentials associated with the user 101. Triggered by the NFC read and managed by the access control application 202, the mobile device 110 uses its local RF transceiver 220 to establish a direct, local communication link 160 (e.g., BLE) with the access controller's local RF transceiver 132. Authentication data (e.g., encrypted credentials or tokens derived from the access control application 202 and user data) is exchanged over this local communication link 160. The access controller 130 verifies the authentication data against the access credentials 146 stored locally in its memory 144. If authentication is successful, the controller 130 operates the lock interface 140 to unlock the electronic lock 104. This primary authentication path does not require immediate communication with a cellular network 150 or a remote cloud server 170.

The system 100 includes connectivity to the remote cloud server 170 through a wide area network (WAN) 172 based on the cellular network 150 (e.g., using the cellular transceiver 240 and/or controller transceiver 134) and/or based on a network connection 174 and a network infrastructure 176 (e.g., a local area network (LAN), accessed using the mobile device transceiver 230, the network transceiver 136, and/or a Wi-Fi access point 178 of the network infrastructure 176). This connectivity supports several functions.

In some implementations, the access controller 130 can operate entirely independently from the network infrastructure 176. The controller transceiver 134 can use CAT-M (e.g., Long Term Evolution M) cellular technology for low-bandwidth cloud connectivity to synchronize credentials and logs. Ethernet and Wi-Fi can be supported (e.g., using the controller's cellular transceiver 134 and/or the controller's network interface 136) but may not be strictly required in some examples, allowing deployment in high-security or remote environments.

In some implementations, a cloud fallback path 152 can be used if the local communication link 160 fails. In this case, the mobile device 110 may use its cellular transceiver 240 to contact the remote cloud server 170. The remote cloud server 170 can authenticate the request and, if valid, send a command through the cellular network 150 to the controller's cellular transceiver 134, and/or through the network connection 174 to the controller's network interface 136, instructing the controller 130 to unlock the access point 102.

In some implementations, the remote cloud server 170 can be used as a centralized repository of user credentials. For example, security personnel can add and remove users from a database of known users who are permitted to access all or a predetermined subset of access points, and these user credentials can be distributed to access controllers 130 at various locations (e.g., push, pull, per-request, cloud fallback).

In some implementations, the controller 130 can upload access logs and download updated credentials to the remote cloud server 170 (e.g., cloud synchronization). For example, by using its cellular transceiver 134 and/or network interface 136, the controller 130 can enable centralized management by the remote cloud server 170 without requiring local servers or reliance on the secure location's 103 network infrastructure 176 (e.g., LAN).

In some implementations, the system 100 can use BLE to perform direct mobile device-to-device authentication. In such examples, in the event of a BLE failure (e.g., due to interference or tampering), the system 100 can be configured to fall back to cloud-based authentication using cellular communications to provide continuity of security and connectivity without slowing down access under normal conditions.

In some implementations, multiple access controllers 130 can be associated with a single customer and/or property through the remote cloud server 170. For example, credential updates and access logs can be synchronized for multiple controllers 130 at multiple access points 102 at one or more locations 103, to enable and provide a unified management interface without needing centralized controllers at each 103.

In some implementations, the access controller 130 can be integrated with and/or made accessible to third-party devices and services. For example, the access controller 130 can be configured to respond to information requests from remote security monitoring systems. In another example, the access controller 130 can be configured to grant physical access to known external users or classes of users, such as first responders (e.g., police, firemen, paramedics).

The controller 130 is powered by a power source 190 and/or by the network infrastructure 176 (e.g., Power over Ethernet, PoE). In some embodiments, the controller 130 can be powered by a utility mains supply (e.g., a wall outlet). In the illustrated example, the power source is a battery. For example, the controller 130 can support PoE or USB-C input, enabling the controller 130 to be powered by power provided by the network infrastructure 176, by off-the-shelf battery packs (e.g., portable cell phone chargers), laptop chargers, AC to USB-C converters, solar powered batteries (e.g., solar generators), or any other appropriate power source. This allows for flexible installations, including locations without wired power, and provides a natural backup power option during outages. If the installation site has network cabling providing PoE, then the controller 130 can receive power and/or data through a single Ethernet cable connected to a PoE switch or injector on the network infrastructure 176. In some embodiments, an uninterruptible power supply (UPS), a USB-C battery, other power source can be used as primary power or can be used redundantly with PoE to power the controller 130.

The processor 142 executes instructions stored in memory 144 to perform the functions of the controller 130, such as communication management, authentication logic, and lock control. The memory 144 stores information such as firmware/instructions, the access credentials 146 (e.g., a list of authorized users/mobile devices, access schedules, cryptographic keys), and access logs. The access credentials 146 can be used for local authentication decisions. Access logs can be used to record access events (e.g., successful and failed entry attempts).

The RF transceiver 132 handles direct, short-range wireless communication with user mobile devices such as the mobile device 110 (e.g., through BLE, Bluetooth, NFC, RFID, Wi-Fi). The cellular transceiver 134 provides connectivity to the remote cloud server 170 via the cellular network 150, for example, for fallback authentication and/or synchronization. In some implementations, use of a low-bandwidth protocol like CAT-M by the cellular transceiver 134 can reduce or minimize power consumption and/or data costs.

The access controller 130 is configured to receive image information from a camera 148 installed near the access point 102. In the illustrated example, the camera 148 is connected directly to the access controller 130 in a stand-alone or self-contained configuration in which additional communication or processing components may not be required. In some embodiments, the controller 130 may communicate with the camera 148 indirectly. For example, the camera 148 may be a network-based camera and the controller 130 and the camera 148 may communicate through the network infrastructure 176 (e.g., RSTP, ONVIF). In another example, the camera 148 may be connected to a network video recorder (NVR) system that can provide image and/or video information to the controller 130. In some implementations, when the user 101 attempts to access the access point 102, the controller 130 can operate the camera 148 to capture images or video of the user 101 and other activity near the access point 102 at the time of entry or attempted entry. In some implementations, the controller 130 can log images or video of the entry attempt in addition to information about the event. In some implementations, the controller 130 can be configured to perform biometric functions (e.g., facial recognition) as an additional security measure (e.g., to detect that the mobile device 110 is being used by someone who does not appear to be the authorized, intended, or expected user 101 associated with the mobile device 110).

In some implementations, the system 100 can provide video intercom functionality to the installation. For example, when the access device authenticates and grants access, a video image can be captured of this event. But in the event that the person does not have previous access credentials for the door, an intercom button can be pressed, and video and audio communications can be opened to any number of predetermined authorized users. This can be done independent of the building network directly to mobile device application users over a cloud connection, or by utilizing the local broadband network of the facility. Access can be granted whether the authorized user is local to the facility or from anywhere in the world, and a video event can be captured verifying remote entry and exit.

In some implementations, the access controller 130 can be configured to perform image and/or video signal processing. For example, the access controller 130 can be configured to compress the images or video before transmitting them over a (possibly) bandwidth constrained or data capped cellular connection. In another example, the access controller 130 may perform operations that data-reduce the image or video information prior to storage or transmission, such as by cropping out unneeded portions of an image or by reducing a video stream to a collection of highlight still images. In some implementations, the access controller 130 can be configured to annotate the image and/or video data prior to storage or transmission. For example, the access controller 130 can overlay time, location, and user identification information on the images or add it as image metadata. In another example, the access controller 130 can receive incorporate information input manually by a user (e.g., security monitoring personnel). In yet another example, the access controller 130 can analyze the image or video data to provide descriptive text (e.g., the approximate height and weight of a person who attempted a failed access, identify a make/model of a getaway vehicle, determine that the person attempting entry has a physical appearance that does not match that of the user whose credentials were used).

In some implementations, the system 100 can operate in a substantially independent (e.g., stand-alone) mode, or in a cloud or cloud-fallback mode. In some other implementations, the system 100 can be adapted for use with other hardware. For example, an application programming interface (API) can be provided for communicating with the access controller 130 and/or the remote cloud server 170 such that other (e.g., third party) hardware and software systems can be integrated into the system 100, or the system 100 can be integrated or retrofitted into other (e.g., existing, third party) security systems to communicate authentication credentials and/or event logs. In various implementations, such communications can be performed device-to-device (e.g., locally, no cloud), or can be performed device-to-cloud-to-device (e.g., a cloud-based translator), or can be performed cloud-to-cloud (e.g., interoperability with third-partly cloud-based systems), or any combination of these or any other appropriate form of machine-to-machine (M2M) communication. The access controller 130 can interface with alarm systems through keybus, signal monitoring, or any other appropriate security system communications format to synchronize intrusion signals with captured video, producing a unified event record before cloud delivery.

The system 100 can deliver video content using a low-bandwidth cellular connection, allowing deployment on isolated or secure local networks and providing a resilient delivery path even if broadband connectivity is lost. Such architectures allow cameras and intrusion devices to be on a segmented network without remote access, reducing or substantially minimizing the risk of cyber-attacks while still maintaining an ability to deliver intrusion and video content to monitoring center or emergency response teams. The video content can be processed by the local device, and formatted to be transmitted over a low cost, low power cellular network such as CAT-M.

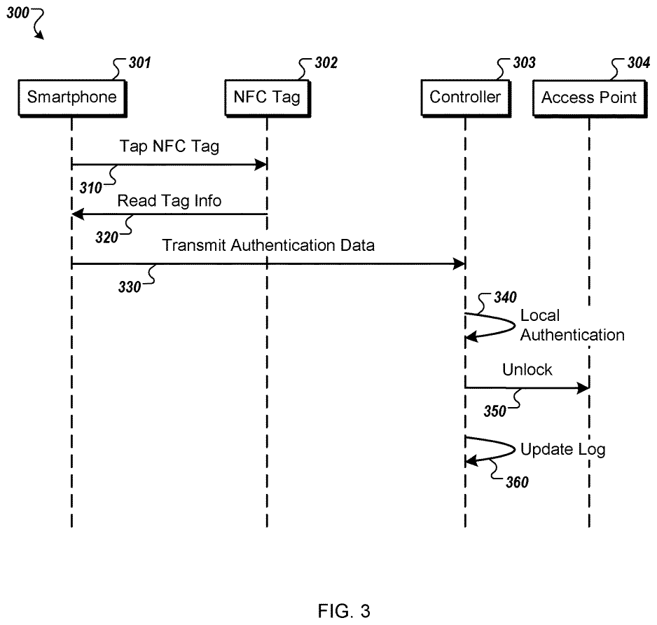

FIG. 3 is a timeline diagram illustrating an example process 300 for local access authentication. In some implementations, the process 300 can be performed by all or part of the system 100 of FIG. 1.

At 310, a user (e.g., the user 101 of FIG. 1) taps a passive NFC tag 302 (e.g., the NFC tag 120) with their mobile device 301 (e.g., the mobile device 110).

At 320, the mobile device's NFC reader (e.g., the NFC reader 210 of FIG. 2) reads data (e.g., an identifier) from the NFC tag 302.

At 330, triggered by the NFC read 320, the mobile device initiates a direct communication link to an access controller 303 (e.g., the controller 130) to transmit a collection of authentication data (e.g., credentials, token) associated with the mobile device 301 or the user of the mobile device 301 to the access controller 303. For example, the access control application 202 can direct the mobile device's local RF transceiver 220 to initiate the local communication link 160 (e.g., BLE connection) with the RF transceiver 132 of the access controller 130 to transmit a security token for the mobile device 301 and an identifier obtained from the NFC tag 302.

The access controller 303 receives the authentication data via its local RF transceiver, and at 340, the access controller 303 performs local authentication by comparing the received data against the access credentials stored in its memory. In some implementations, this step does not require a WAN connection or cloud communication.

If authentication is successful, then at 350 the access controller 303 sends a signal or command to an access point 304 (e.g., the access point 102) to unlock an electronic lock (e.g., the lock 104), thereby granting access. The access controller 303 can update 360 a log to record the access. If authentication is not successful, then the process 300 may end or the access controller 303 may update 360 the log to record the failed attempt.

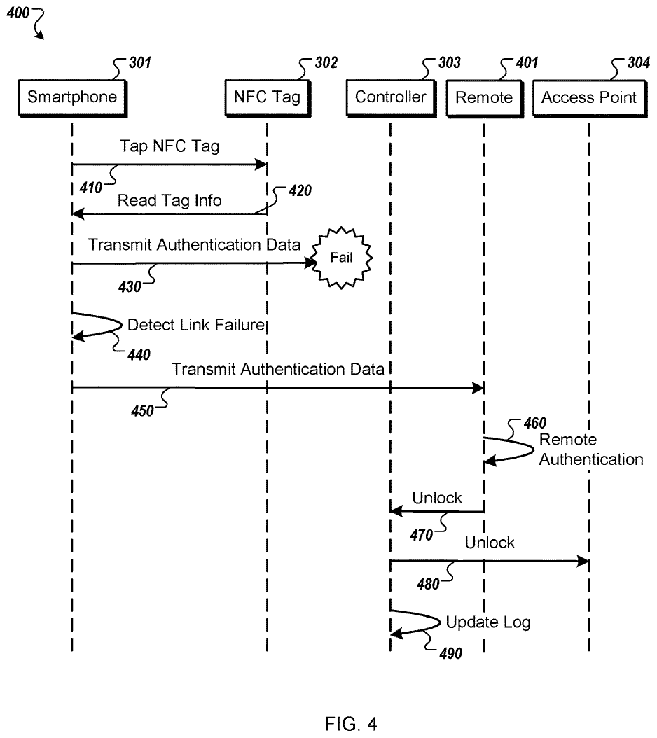

FIG. 4 is a flow diagram illustrating an example process 400 for cloud fallback authentication. In some implementations, the process 300 can be performed by all or part of the system 100 of FIG. 1.

At 410, the user taps the passive NFC tag 302 with the mobile device 301. At 420, the mobile device's NFC reader reads data (e.g., an identifier) from the NFC tag 302.

At 430, the mobile device 301 attempts to establish the local RF communication link with the access controller 303 to send authentication data, such as a security token for the mobile device 301 and an identifier obtained from the NFC tag 302 (similar to 330).

At 440, the mobile device 301 determines that the local RF link establishment or communication has failed (e.g., due to interference, distance, or tampering), or that the access controller 303 failed to authenticate the mobile device 301 (e.g., the mobile device 301 does not appear in a list of known and authorized devices).

At 450, if the local RF communication failed or the mobile device 301 is not recognized, then the mobile device 301 initiates communication with a remote cloud server 401 (e.g., the remote cloud server 170, through the cellular network 150 or the WAN 172) to send an access request. In the example of a communications failure, use of the remote cloud server 401 can provide an alternative communication path to allow the mobile device to be authenticated and permit access to the access point 304 (e.g., unlocking the access point 102). In the example of an authentication failure, use of the remote cloud server 401 can provide a way to overcome an outdated authentication list at the access controller 303 (e.g., when a new user is added to the system 100 but their identity has not yet been pushed out to the access controller 303).

In some implementation, the access controller 303 may maintain its list of known users as a cache, in which a finite database or list of the identities of only the most frequently or recently seen mobile devices 301 is stored locally, whereas the remote cloud server 401 can hold a complete list of the identities. For example, the access controller 303 may be implemented using a microcontroller with a relatively small amount of available memory or storage, and as such may store only a relatively small collection (e.g., 10, 100, 1000) of identifiers for most recent/frequent users of the access point 304. When a known user makes a first or infrequent visit to the site of the access point 304, their identity may not be cached in the access controller 303. As such, when the user attempts to enter and fails to be recognized, either the access controller 303 or the mobile device 301 can communicate with the remote cloud server 401 to request identification against the global list of known users and cause the access point 304 to be unlocked. Part of this process may include adding the visiting user's identity to the identifier cache on the access controller 303 in order to make subsequent access requests occur locally (e.g., as in the example process 300).

In some implementations, the use of an identification cache can enhance systemwide security. By caching the identities of only the most recently or frequently seen users, outdated credentials may be purged from the system on a substantially continuous or periodic passive basis, automatically helping to prevent a de-authorized user from entering some access points. For example, an authorized user may normally enter through a secured front door but rarely through the rear door (with its own independent access controller), and as such their identity and access credentials may be cached in the front door's access controller but not at the back door. If this user is subsequently de-authorized (e.g., fired) and has their access credentials revoked in the remote cloud server 401, the recently de-authorized (and now potentially disgruntled and/or malicious) user may rush to the back door in an attempt to re-enter the premises before their credentials have been completely revoked from the system. However, since in this scenario the user rarely or never used the back door before, the back door's access controller may not have any potentially exploitable credentials for de-authorized user in its cache in its first place. As such, the de-authorized user will not be recognized and denied entry. A subsequent fallback on cloud-based identification would cause the access request to be sent to the remote cloud server 401, where the de-authorized user has already been revoked or deleted. Furthermore, the remote cloud server 401 may recognize the unauthorized access attempt and respond by logging the attempt and/or by notifying security, law enforcement, or other personnel.

At 460, the remote cloud server 401 receives the request and performs authentication based on its records (e.g., verifying user, mobile device, and target controller/door).

At 470, if authentication by the remote cloud server 401 is successful, then the remote cloud server 401 sends an ‘unlock’ command to the access point 304 (e.g., through the cellular network 150 or the WAN 172).

At 480, the access controller 303 receives the command and, responsive to the valid command 470 from the remote cloud server 401, the access controller 303 operates the access point 304 (e.g., to unlock the electronic lock 104). The event is logged at 490.

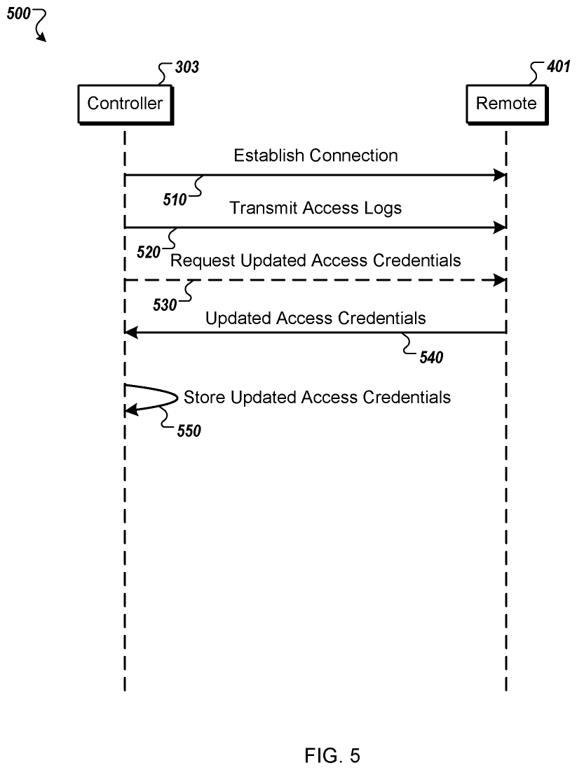

FIG. 5 is a flow diagram illustrating an example process 500 for cloud synchronization. In some implementations, the process 500 can be performed by part or all of the example system 100 of FIG. 1. In some implementations, the process 500 can be run periodically or can be triggered by predetermined events or commands.

At 510, the access controller 303 establishes a communication session 510 with the remote cloud server 401 (e.g., using the cellular transceiver 134 and the cellular network 150, and/or using the network interface 136 and the WAN 172).

At 520, the access controller 303 transmits accumulated access logs from its memory to the remote cloud server 401. In some implementations, this can promote centralized monitoring and/or auditing of access activities.

At 530, the access controller 303 requests updated access credentials (e.g., new authorized users, revoked credentials, updated schedules) from the remote cloud server 401.

At 540, the remote cloud server 401 sends updated access credentials (e.g., new authorized users, revoked credentials, updated schedules) to the access controller. In some implementations, the transmission at 540 can be requested by the request 530. In some implementations, the transmission 540 may be initiated (e.g., unsolicited, on a predetermined basis or interval, in response to predetermined events) by the remote cloud server 401.

At 550, the access controller 303 stores the received updated credentials in its memory, to promote the accuracy and contemporaneity of its local authentication database. In some implementations, the process 500 can be performed with multiple controllers across one or more locations to be managed centrally.

In some implementations, the systems described herein can be configured to operate in a primarily decentralized mode. For example, the example controller 130 of FIG. 1 (or multiples of such controllers) can be configured to operate in a completely stand-alone configuration, in which access credentials 146 are created, stored, maintained, and/or deleted in the memory 144 (e.g., by using a computer, mobile device, or other local device). In another example, the example controller 130 can be configured to operate in a primarily stand-alone configuration, with cloud server providing and/or receiving updates to the access credentials 146 on a periodic or on-demand basis.

In some implementations, the systems described herein can be configured to operate in a primarily decentralized mode. For example, the example controller 130 of FIG. 1 (or multiples of such controllers) can be configured to attempt to authenticate substantially all access attempts against the remote cloud server 170, and fall back upon local stored or cached credentials only in the event of a failure to communicate with the remote cloud server 170. In such configurations, a user 101 can still be granted substantially secure access through the access point 102 even if access to the WAN 172 has been cut or is unreliable.

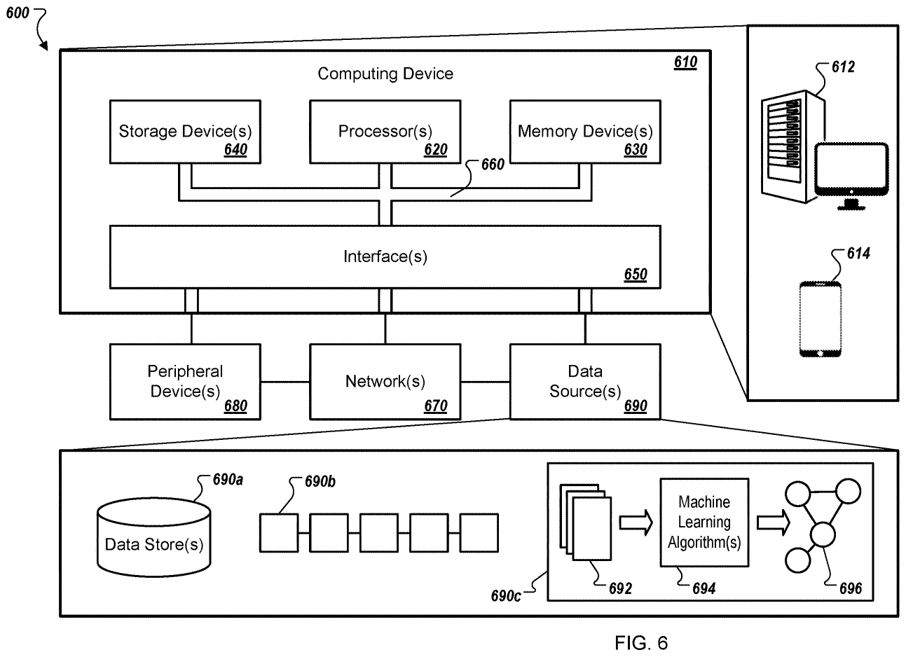

FIG. 6 is a schematic diagram that shows an example of a computing system 600 that may be used to implement the techniques described herein. The computing system 600 includes one or more computing devices (e.g., computing device 610), which may be in wired and/or wireless communication with various peripheral device(s) 680, data source(s) 690, and/or other computing devices (e.g., over network(s) 670). The computing device 610 may represent various forms of stationary computers 612 (e.g., workstations, kiosks, servers, mainframes, edge computing devices, quantum computers) and mobile computers 614 (e.g., laptops, tablets, mobile phones, personal digital assistants, wearable devices). In some implementations, the computing device 610 may be included in (and/or in communication with) various other sorts of devices, such as data collection devices (e.g., devices that are configured to collect data from a physical environment, such as microphones, cameras, scanners, sensors), robotic devices (e.g., devices that are configured to physically interact with objects in a physical environment, such as manufacturing devices, maintenance devices, object handling devices), vehicles (e.g., devices that are configured to move throughout a physical environment, such as automated guided vehicles, manually operated vehicles), or other such devices. Each of the devices (e.g., stationary computers, mobile computers, and/or other devices) may include components of the computing device 610, and an entire system may be made up of multiple devices communicating with each other. For example, the computing device 610 may be part of a computing system that includes a network of computing devices, such as a cloud-based computing system, a computing system in an internal network, or a computing system in another sort of shared network. Processors of the computing device 610 and other computing devices of a computing system may be optimized for different types of operations, secure computing tasks, and any other appropriate form of computerized process. The components shown herein, and their functions, are meant to be examples, and are not meant to limit implementations of the technology described and/or claimed in this document.

The computing device 610 includes processor(s) 620, memory device(s) 630, storage device(s) 640, and interface(s) 650. Each of the processor(s) 620, the memory device(s) 630, the storage device(s) 640, and the interface(s) 650 are interconnected using a system bus 660. The processor(s) 620 are capable of processing instructions for execution within the computing device 610, and may include one or more single-threaded and/or multi-threaded processors. The processor(s) 620 are capable of processing instructions stored in the memory device(s) 630 and/or on the storage device(s) 640. The memory device(s) 630 may store data within the computing device 610, and may include one or more computer-readable media, volatile memory units, and/or non-volatile memory units. The storage device(s) 640 may provide mass storage for the computing device 610, may include various computer-readable media (e.g., a floppy disk device, a hard disk device, a tape device, an optical disk device, a flash memory or other similar solid state memory device, or an array of devices, including devices in a storage area network or other configurations), and may provide date security/encryption capabilities.

The interface(s) 650 may include various communications interfaces (e.g., USB, Near-Field Communication (NFC), Bluetooth, Bluetooth Low Energy, Zigbee, Z-Wave, Thread, Wi-Fi, Ethernet, wireless Ethernet, etc.) that may be coupled to the network(s) 670, peripheral device(s) 680, and/or data source(s) 690 (e.g., through a communications port, a network adapter, etc.). Communication may be provided under various modes or protocols for wired and/or wireless communication. Such communication may occur, for example, through a transceiver using a radio-frequency. As another example, communication may occur using light (e.g., laser, infrared) to transmit data. As another example, short-range communication may occur, such as using Bluetooth, Wi-Fi, or other such transceiver. In addition, a GPS (Global Positioning System) receiver module may provide location-related wireless data, which may be used as appropriate by device applications. The interface(s) 650 may include a control interface that receives commands from an input device (e.g., operated by a user) and converts the commands for submission to the processors 620. The interface(s) 650 may include a display interface that includes circuitry for driving a display to present visual information to a user. The interface(s) 650 may include an audio codec which may receive sound signals (e.g., spoken information from a user) and convert it to usable digital data. The audio codec may likewise generate audible sound, such as through an audio speaker. Such sound may include real-time voice communications, recorded sound (e.g., voice messages, music files), and/or sound generated by device applications.

The network(s) 670 may include one or more wired and/or wireless communications networks, including various public and/or private networks. Examples of communication networks include a LAN (local area network), a WAN (wide area network), and/or the Internet. The communication networks may include a group of nodes (e.g., computing devices) that are configured to exchange data (e.g., analog messages, digital messages), through telecommunications links. The telecommunications links may use various techniques (e.g., circuit switching, message switching, packet switching) to send the data and other signals from an originating node to a destination node. In some implementations, the computing device 610 may communicate with the peripheral device(s) 680, the data source(s) 690, and/or other computing devices over the network(s) 670. In some implementations, the computing device 610 may directly communicate with the peripheral device(s) 680, the data source(s), and/or other computing devices.

The peripheral device(s) 680 may provide input/output operations for the computing device 610. Input devices (e.g., keyboards, pointing devices, touchscreens, microphones, cameras, scanners, sensors) may provide input to the computing device 610 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices) may provide output from the computing device 610 (e.g., user-directed output and/or other output that results in actions being performed in a physical environment). Other kinds of devices may be used to provide for interactions between users and devices. For example, input from a user may be received in any form, including visual, auditory, or tactile input, and feedback provided to the user may be any form of sensory feedback (e.g., visual feedback, auditory feedback, or tactile feedback).

The data source(s) 690 may provide data for use by the computing device 610, and/or may maintain data that has been generated by the computing device 610 and/or other devices (e.g., data collected from sensor devices, data aggregated from various different data repositories). In some implementations, one or more data sources may be hosted by the computing device 610 (e.g., using the storage device(s) 640). In some implementations, one or more data sources may be hosted by a different computing device. Data may be provided by the data source(s) 690 in response to a request for data from the computing device 610 and/or may be provided without such a request. For example, a pull technology may be used in which the provision of data is driven by device requests, and/or a push technology may be used in which the provision of data occurs as the data becomes available (e.g., real-time data streaming and/or notifications). Various sorts of data sources may be used to implement the techniques described herein, alone or in combination.

In some implementations, a data source may include one or more data store(s) 690a (e.g., databases, or other sorts of data management systems). The data store(s) may be provided by a single computing device or network (e.g., on a file system of a server device) or provided by multiple distributed computing devices or networks (e.g., hosted by a computer cluster, hosted in cloud storage). In some implementations, a database management system (DBMS) may be included to provide access to data contained in database(s) (e.g., using a query language and/or application programming interfaces (APIs)). The database(s), for example, may include relational databases, object databases, structured document databases, unstructured document databases, graph databases, and other appropriate types of databases.

In some implementations, a data source may include one or more blockchains 690b. A blockchain may be a distributed ledger that includes blocks of records that are securely linked by cryptographic hashes. Each block of records includes a cryptographic hash of the previous block, and transaction data for transactions that occurred during a time period. The blockchain may be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain may maintain data quality (e.g., through data replication) and may improve data trust (e.g., by reducing or eliminating central data control).

In some implementations, a data source may include one or more machine learning systems 690c. The machine learning system(s) 690c, for example, may be used to analyze data from various sources (e.g., data provided by the computing device 610, data from the data store(s) 690a, data from the blockchain(s) 690b, and/or data from other data sources), to identify patterns in the data, and to draw inferences from the data patterns. In general, training data 692 may be provided to one or more machine learning algorithms 694, and the machine learning algorithm(s) may generate a machine learning model 696. Execution of the machine learning algorithm(s) may be performed by the computing device 610, or another appropriate device. Various machine learning approaches may be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques may be employed, including but not limited to convolutional neural networks (CNNs), deep neural networks (DNNs), recurrent neural networks (RNNs), and other types of multi-layer neural networks. With respect to the technology described herein, the training data can include data that represents user authentication and/or access logs. The machine learning model that results from the machine learning algorithm(s) can be used to predict user access patterns at various locations or to identify symptoms or causes of authentication or communication failures. Use of the machine learning model can provide, for example, the benefit of enhancing access security, enhancing system reliability, and/or identifying and resolving communications or access issues.

Various implementations of the systems and techniques described herein may be realized in digital electronic circuitry, integrated circuitry, specially designed ASICs (application specific integrated circuits), computer hardware, firmware, software, and/or combinations thereof. A computer program product may be tangibly embodied in an information carrier (e.g., in a machine-readable storage device), for execution by a programmable processor. Various computer operations (e.g., methods described in this document) may be performed by a programmable processor executing a program of instructions to perform functions of the described implementations by operating on input data and generating output. The described features may be implemented in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment. A computer program product may be a computer-or machine-readable medium, such as a storage device or memory device. As used herein, the terms machine-readable medium and computer-readable medium refer to any computer program product, apparatus, and/or device (e.g., magnetic discs, optical disks, memory) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and may be a single processor or one of multiple processors of any kind of computer. Generally, a processor will receive instructions and data from a read-only memory or a random-access memory or both. The elements of a computer are a processor for executing instructions and one or more memory devices for storing instructions and data. Generally, a computer may also include, or may be operatively coupled to communicate with, one or more mass storage devices for storing data files. Such devices may include magnetic disks (e.g., internal hard disks and/or removable disks), magneto-optical disks, and optical disks. Storage devices suitable for tangibly embodying computer program instructions and data may include all forms of non-volatile memory, including by way of example semiconductor memory devices, flash memory devices, magnetic disks (e.g., internal hard disks and removable disks), magneto-optical disks, and optical disks. The processor and the memory may be supplemented by, or incorporated in, ASICs (application-specific integrated circuits).

The systems and techniques described herein may be implemented in a computing system that includes a back end component (e.g., a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). The computer system may include clients and servers, which may be generally remote from each other and typically interact through a network, such as the described one. The relationship of client and server arises by virtue of computer programs running on the respective computers and having a client-server relationship to each other.

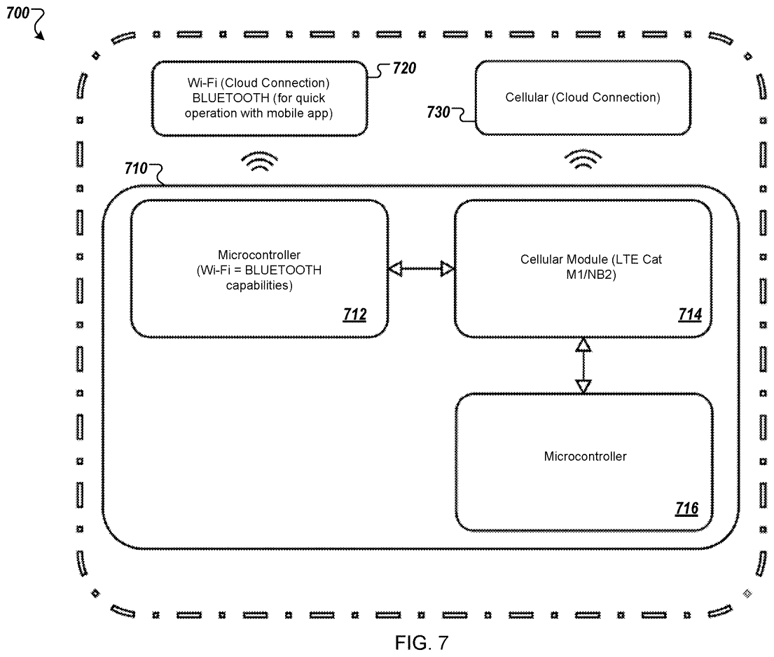

FIGS. 7-10 show various details of one example implementation of the innovation described herein. FIGS. 11-22 are block diagrams of various use cases of the innovation described herein.

FIG. 7 is a block diagram illustrating an example hardware architecture 700 for an access controller, such as the access controller 130 described with reference to FIG. 1. The hardware architecture 700 includes a main module 710 housing a collection of interconnected processing and communication components. This architecture 700 supports a decentralized, minimal-infrastructure system that can operate independently of centralized access control panels and legacy wired networks. By integrating multiple specialized processing units into a single main module 710, the hardware architecture 700 provides a flexible and scalable solution that can be deployed across a variety of secure locations, ranging from high traffic entryways to remote, off grid facilities.

The main module 710 includes a first microcontroller 712 configured to provide local wireless communications. For example, the first microcontroller 712 can be an ESP32 WROVER E microcontroller having integrated Wi-Fi and BLUETOOTH capabilities. The first microcontroller 712 is communicably coupled to a local wireless interface 720. The local wireless interface 720 and the first microcontroller 712 can facilitate a wireless (e.g., BLUETOOTH or Bluetooth Low Energy (BLE)) connection for quick operation and local authentication with a mobile device. In practice, when a user's mobile device reads an associated NFC tag, the mobile device initiates a secure payload transfer to the first microcontroller 712 via the local wireless interface 720. In some examples, the local wireless interface 720 and the first microcontroller 712 can also facilitate a Wi-Fi connection to a local area network or a remote cloud server for supplementary data exchange. By handling primary authentication locally (e.g., via the BLUETOOTH connection), the hardware architecture 700 can improve system responsiveness by reducing network latency and bandwidth consumption that would otherwise be required for cloud-based authentication. This edge-based processing provides a measurable improvement to the operation of the underlying computer network by reducing external queries, thereby freeing up external network resources and helping to maintain access point operation even during internet service outages.

The main module 710 further includes a cellular module 714 configured to provide wide area network connectivity. In some implementations, the cellular module 714 can be a Telit ME310G1 WW cellular module configured to communicate using dual mode LTE Cat M1 or NB2 protocols. The cellular module 714 is communicably coupled to a cellular interface 730 to establish a cellular connection to the remote cloud server. These specific cellular protocols are particularly advantageous for connected devices because they offer extended range and deep indoor signal penetration, allowing the hardware architecture 700 to maintain connectivity in physically obstructed environments like concrete stairwells or subterranean garages. This cellular connection can be utilized as a resilient cloud fallback mechanism if the local BLUETOOTH connection fails due to local interference or tampering. The cellular connection can also be used for synchronizing access logs, downloading firmware updates, and receiving revoked user credentials without relying on a local building network. Operating over a low bandwidth cellular network reduces power consumption and data transmission costs, enabling the device to function efficiently on flexible power sources such as battery packs.

The main module 710 also includes a second microcontroller 716, such as an STM32G030K6 microcontroller. The second microcontroller 716 acts as the secure logic core of the system and can be communicably coupled to the first microcontroller 712 and the cellular module 714 to coordinate data exchange, process access decisions, and operate the physical lock interface. In some implementations, the multiple processor arrangement of the hardware architecture 700 allows the communication tasks handled by the first microcontroller 712 and the cellular module 714 to be logically segmented from the core access control logic handled by the second microcontroller 716. For example, the communication modules forward incoming authorization requests to the second microcontroller 716, which then independently queries a locally stored credential cache to determine if access should be granted. If approved, the second microcontroller 716 transmits the physical unlock signal via connected relays or Wiegand protocol outputs. This segmentation can improve the security and operational stability of the hardware architecture 700 by isolating the core lock actuation mechanism from the network facing interfaces. Consequently, even if a malicious actor were to compromise the wireless or cellular interfaces, they may be prevented from directly triggering the door mechanism, providing a distinct technological enhancement to the physical security of the managed access point.

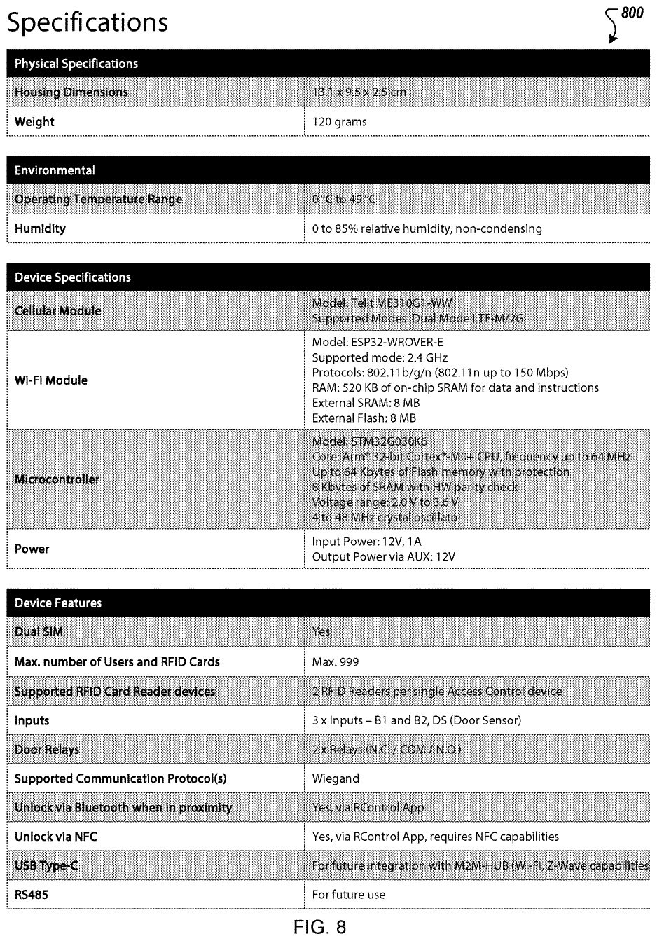

FIG. 8 is a table illustrating example specifications 800 for the access controller architecture described in the present disclosure. In some implementations, the hardware components and operational parameters can be selected to optimize for both low power consumption and high reliability in diverse environmental conditions. By selecting components that balance processing capability with thermal and electrical efficiency, the architecture can support long term deployment in environments that may lack stable infrastructure.

The physical specifications of the access controller can include housing dimensions of approximately 13.1 by 9.5 by 2.5 centimeters, with a total weight of approximately 120 grams. These compact dimensions facilitate flexible installation in constrained spaces near access points, such as within narrow door frames or inside existing electrical junction boxes. The lightweight nature of the device allows for mounting on a variety of surfaces, including glass or lightweight partitions, without the need for heavy duty mounting hardware. The environmental operating range for the device can include temperatures from approximately $0\hat{ }{\circ}C$ to $49\hat{ }{\circ}C$, with a relative humidity range of 0 to 85 percent, non-condensing. These parameters ensure that the controller remains operational in standard building environments as well as semi-protected outdoor or industrial locations. For instance, the non-condensing humidity rating can help to ensure that the internal circuitry remains protected from moisture damage when the device is housed in an appropriately rated external enclosure in high humidity regions.

The device specifications further detail the processing and communication resources that enable the decentralized functionality of the system. For example, the cellular module can include a Telit ME310G1-WW model supporting dual mode LTE-M and 2G connectivity. The inclusion of 2G fallback capability is particularly advantageous for deployments in remote regions where 4G or LTE-M coverage may be intermittent or unavailable, ensuring that the device maintains its connection to the remote cloud server regardless of local network upgrades. The Wi-Fi and local wireless module can include an ESP 32-WROVER-E microcontroller supporting the 802.11b/g/n protocols and providing 520 KB of on-chip SRAM. To support the local storage of access credentials and logs, the system can further include 8 MB of external SRAM and 8 MB of external flash memory. This expanded memory capacity is particularly advantageous for maintaining a large local cache of authorized user identifiers and encrypted security tokens. By leveraging this external memory, the device can perform thousands of local authentication decisions and store detailed audit trails locally, allowing the system to continue functioning at full capacity during a total wide area network outage. Once connectivity is restored, the device can use its internal storage to synchronize the accumulated logs with the remote system without data loss.

The main microcontroller can include an STM32G030K6 model, which features an ARM 32-bit Cortex-M0+ CPU capable of operating at frequencies up to 64 MHz. This specific processor architecture is selected for its high performance to power ratio, which is critical when the device is operating on backup battery power. This microcontroller can include 64 KB of flash memory with protection and 8 KB of SRAM with hardware parity checks, thereby providing a hardware-level integrity check that improves the overall reliability and security of the processing operations by detecting and mitigating data corruption or unauthorized firmware modifications. The power specifications for the device can include a 12V, 1 A input, with the ability to provide 12V output power via an auxiliary port. This auxiliary output can be used to power connected peripherals such as an electronic door strike, a magnetic lock, or an external alarm siren, thereby centralizing the power management for the entire access point within a single controller unit.

Additional device features can include support for dual SIM cards, which provides carrier redundancy to prevent communication failures if one cellular provider experiences an outage or signal degradation. This ensures that the cloud fallback and synchronization features remain available at all times. The system can support a maximum of 999 users and RFID cards stored locally, making it suitable for a wide range of applications from residential buildings to medium-sized commercial enterprises. The controller can interface with up to two RFID readers per access control device, allowing for managed entry and exit monitoring at a single access point. The controller can include multiple inputs, such as door sensor (DS) and auxiliary inputs (B1 and B2), as well as two door relays for controlling lock states. These relays can be configured in normally closed or normally open states to accommodate different hardware types. Communication with peripheral readers can be performed using the Wiegand protocol, ensuring compatibility with a vast ecosystem of existing security hardware. Furthermore, the controller can support unlocking via BLUETOOTH and NFC via a mobile application, and it includes a USB Type-C port for future integrations, such as connecting to a Z-Wave or Zigbee hub, and an RS485 interface for serial communication with complex building automation systems. These integrated features allow the controller to serve as a comprehensive, standalone security hub that bridges the gap between legacy hardware and modern, mobile driven access solutions.

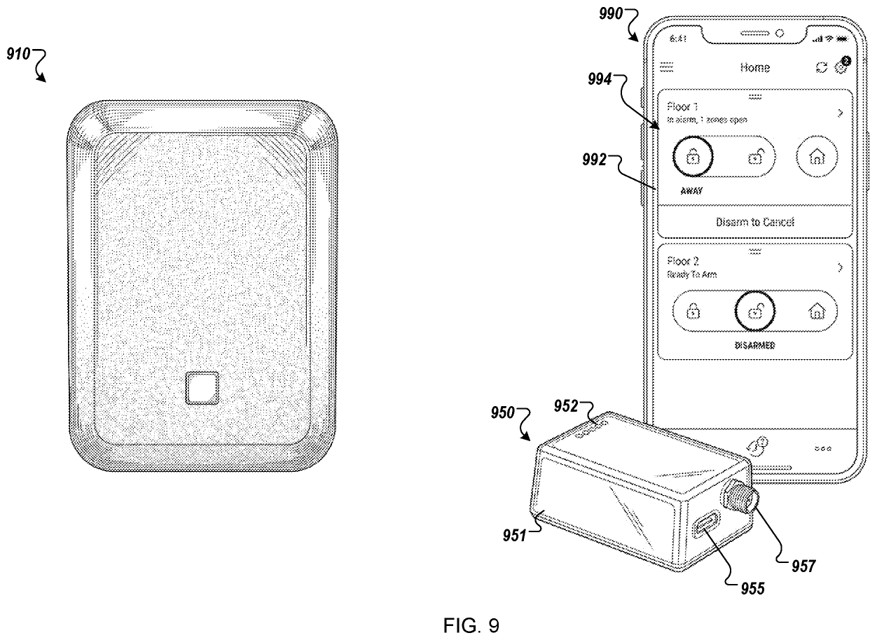

FIG. 9 illustrates an example physical access controller 910 and a corresponding mobile application interface for the access control system described herein. The access controller 910 can operate as a drop in single door access control system having a generally rectangular profile with rounded corners. The access controller 910 can be designed for surface mounting near an access point and can facilitate installation with reduced wiring requirements to modernize legacy security infrastructures. A front face of the access controller 910 can include a visual indicator, such as an LED window or a translucent section, configured to provide local status feedback to a user. For example, the visual indicator can change color to indicate whether an access request has been granted or denied. Furthermore, the access controller 910 can feature a dual SIM architecture and can be configured to provide universal compatibility with peripheral Wiegand protocol readers while facilitating access control utilizing passive NFC tags. In some embodiments, the access controller 910 can be an M2M-AXS, a drop in single door access control system developed by M2M Services.

A perspective view illustrates a communicator device 950 enclosed in a compact, generally rectangular housing 951. The top surface of the communicator device 950 can include a status indicator array, such as a sequence of light emitting diodes 952, configured to visually communicate operational states including cellular signal strength, power status, or active data transmission. In some embodiments, the housing 951 can also feature device identification indicia, such as scannable barcodes and alphanumeric identifiers, to streamline device provisioning and installation. The communicator device 950 is associated with the system and can act as a cellular replacement for Plain Old Telephone Service (POTS) lines. The device 950 includes a power input port 955 (e.g., a Universal Serial Bus Type C port) configured to receive power from an external battery pack or a wall adapter. The device 950 also includes an antenna connector 957, such as a gold-plated SMA connector, configured to couple an internal cellular module to an external cellular antenna. Providing the external antenna connector 957 allows the device 950 to maintain robust cellular connectivity even when installed inside a metal utility cabinet or deep within a building structure. Furthermore, the internal cellular module can include a dual SIM radio configured to support multiple distinct cellular networks (e.g., a first cellular carrier such as AT&T and a second distinct cellular carrier such as Verizon) concurrently on the same radio hardware, operating over protocols such as LTE M. This dual SIM configuration can provide robust carrier redundancy for the access controller, offering a highly adaptable configuration to maintain connectivity across multiple network standards. The device 950 can also include interfaces for legacy panel integration, such as a keybus interface, to bridge traditional alarm systems with modern cellular cloud connectivity. In some implementations, the device 950 can be a 5G ready, dual SIM cellular communicator. In some embodiments, the device 950 can be a “MINI-LTE-M-AV” developed by M2M Services.

FIG. 9 further illustrates a mobile device 990 executing a dedicated access control application 994, which can be referred to in some examples as an RControl application. The mobile device 990 presents a graphical user interface 992 configured to facilitate property wide configuration, remote control, and user management for one or more access controllers. The system can be deployed in a centrally managed deployment model, where the graphical user interface 992 provides seamless administration and subscription management. The graphical user interface 992 can display real time status information for multiple discrete access points or security zones, which are illustrated in this example as a first floor and a second floor. The graphical user interface 992 can dynamically update to reflect detailed alarm conditions and states, such as displaying text corresponding to an active alarm state (e.g., “In alarm, 1 zones open”), an armed state (e.g., “AWAY”), a ready state (e.g., “Ready To Arm”), or a disarmed state (e.g., “DISARMED”), based on synchronization data received from the remote cloud server or directly from the access controllers via local wireless communication.

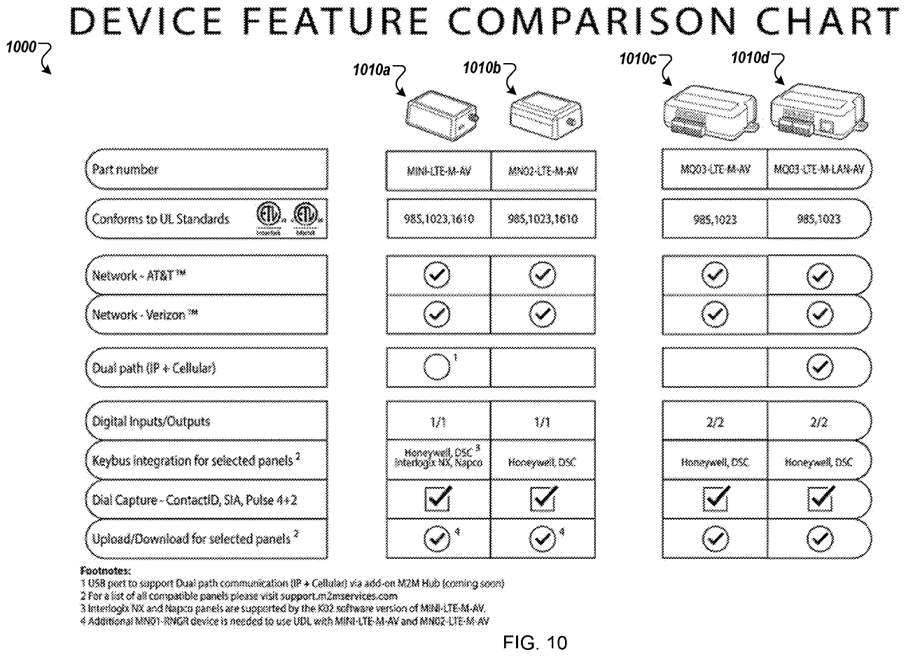

FIG. 10 is a comparison chart 1000 illustrating various features and configurations for a family of communicator devices and access controllers, such as the communicator device 950 and the access controller 910 described with reference to FIG. 9. The comparison chart 1000 provides a technical overview of how different implementations can be tailored to meet specific security standards, regulatory mandates, and networking requirements across a diverse range of deployment environments. By presenting a modular family of devices, the comparison chart 1000 demonstrates a scalable architecture that can accommodate everything from simple residential entryways to complex, high security commercial facilities.

In some implementations, the comparison chart 1000 identifies a collection of part numbers or model designations, including a communicator device 1010a (e.g., MINI LTE M AV developed by M2M Services), a communicator device 1010b (e.g., MN02 LTE M AV developed by M2M Services), a communicator device 1010c (e.g., MQ03 LTE M AV developed by M2M Services), and a communicator device 1010d (e.g., MQ03 LTE M LAN AV developed by M2M Services). Each of these communicator devices 1010a through 1010d can be configured to conform to specific safety and performance standards established by organizations such as Underwriters Laboratories (UL) or Intertek (ETL). For example, the communicator device 1010a and the communicator device 1010b can be certified under standards such as UL 985 for household fire warning system units, UL 1023 for household burglar alarm system units, and UL 1610 for central station burglar alarm units. These certifications help to ensure that the devices meet rigorous requirements for electrical safety, signal reliability, and environmental resilience, which may be a prerequisite for insurance compliance or local building codes in various jurisdictions.

The comparison chart 1000 further details the wide area network connectivity options available across the device family. In some implementations, the communicator devices 1010a through 1010d can be configured to communicate over specific cellular networks provided by major carriers, such as an AT&T network or a Verizon network. This allows an installer to select a hardware version that is optimized for the strongest available signal at a particular geographic location. Certain models, such as the communicator device 1010d, can support dual path communication. This dual path functionality allows the device to communicate via both an Internet Protocol (IP) connection (e.g., a wired Ethernet or Wi-Fi connection) and a cellular connection concurrently or as a primary and backup pair. This arrangement provides a significant technological improvement to system reliability by ensuring that if a building broadband connection is lost or compromised, the device can automatically transition to the cellular path to maintain an uninterrupted connection with the remote cloud server. This substantially continuous connectivity is particularly advantageous for life safety and high value asset protection where even a brief lapse in communication could have serious security consequences.

The hardware interfaces and physical capabilities can also vary between the different models illustrated in the comparison chart 1000 to suit different installation scales. For example, the communicator devices 1010a through 1010d can include varying numbers of digital inputs and outputs (I/O) to monitor sensors or actuate external equipment. While the communicator device 1010a can include a single input and single output (1/1) for a streamlined installation, other models like the communicator device 1010c can include two inputs and two outputs (2/2) to support more complex configurations involving multiple door contacts or request to exit (REX) devices. Furthermore, some implementations can include a USB port to support dual path communication via an add on peripheral hub, such as an M2M Hub. This expandability allows the system to grow with the needs of the property without necessitating a complete hardware replacement.

The comparison chart 1000 also illustrates the advanced capability of the devices to integrate with legacy security hardware via keybus or dial capture interfaces. For instance, several models are shown to support direct keybus integration for selected panels from manufacturers such as Honeywell, DSC, Interlogix NX, and Napco. Dial capture capabilities can also be included to interpret and transmit alarm signals from legacy systems that were originally designed for traditional telephone lines. The communicator devices can translate these legacy signals into modern data formats such as ContactID, SIA, or Pulse 4+2 for transmission over the cellular or IP network. Additionally, certain models can support remote upload and download (UDL) functionality for specific panels, which may involve the use of an additional hardware device such as an MN01 RNGR. This UDL support allows a technician to remotely program or troubleshoot the security system from a central location, significantly reducing the need for onsite service visits and improving the overall efficiency of system maintenance and reducing network downtime. By providing these diverse and robust integration options, the comparison chart 1000 demonstrates how the system can be effectively retrofitted into a wide variety of existing security environments, serving as a comprehensive bridge that brings legacy hardware into a modern, cellular connected ecosystem.

FIG. 11 illustrates example power configurations 1100a and 1100b for an access controller 130 managing an access point 1106. In some implementations, the access controller 130 can be configured to support redundant power inputs to facilitate substantially continuous operation during environmental disruptions or targeted tampering.

In a first configuration 1100a, the access controller 130 is deployed to secure the access point 1106, which is illustrated as a door. The access controller 130 can receive electrical power from a primary power source 1102. The primary power source 1102 can represent a traditional wired power connection, such as a direct connection to mains utility power, a dedicated low voltage power supply, or a Power over Ethernet connection provided through a local area network infrastructure. Concurrently, the access controller 130 can be physically coupled to a secondary power source 1104. In some examples, the secondary power source 1104 can be a commercially available portable battery pack or a localized uninterruptible power supply. The secondary power source 1104 can connect to the access controller 130 via a standardized interface, such as a Universal Serial Bus Type C connection. In this first configuration 1100a, the access controller 130 can draw its operational power primarily from the primary power source 1102, while the secondary power source 1104 remains in a standby state or receives a trickle charge.

In a second configuration 1100b, a power failure event is illustrated wherein the primary power source 1102 is severed, disabled, or otherwise becomes unavailable. In response to detecting a voltage drop or a complete loss of power from the primary power source 1102, the access controller 130 can automatically and seamlessly transition to drawing operational power from the secondary power source 1104. By utilizing the low bandwidth processing and communication modules, such as the low bandwidth cellular transceivers and BLUETOOTH modules described previously, the secondary power source 1104 can sustain the operation of the access controller 130 for an extended duration.

This redundant power architecture can provide a significant technological improvement to the physical security and reliability of the access point 1106. Traditional access control panels often become inoperable during a building wide power outage unless supported by expensive, centralized, and heavy backup battery systems. By contrast, equipping the decentralized access controller 130 with the ability to accept standard Universal Serial Bus Type C power allows installers to deploy cost effective, localized backup power directly at the door. This helps to ensure that localized authentication via local wireless communication, as well as cloud fallback authentication via cellular networks, remains fully functional even when the broader building infrastructure is compromised.

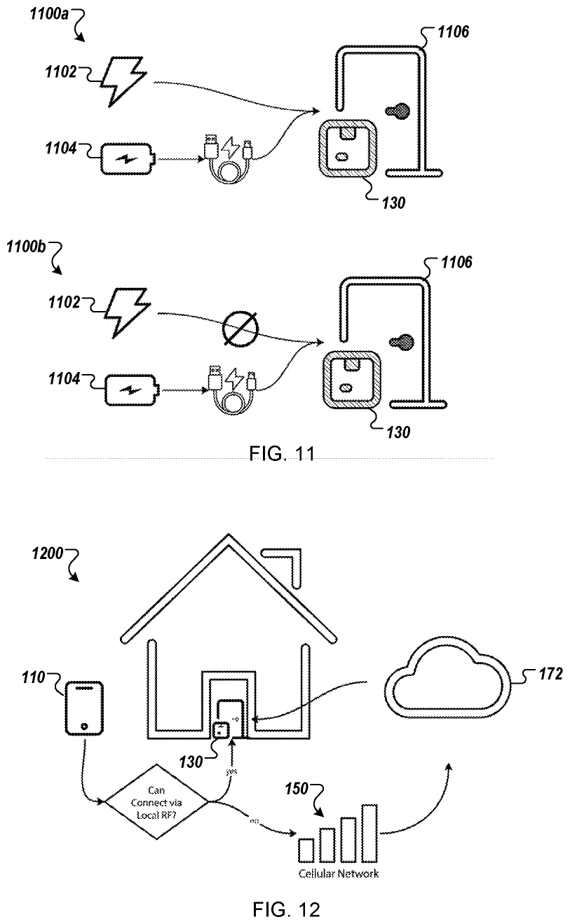

FIG. 12 is a schematic diagram illustrating example network routing logic 1200 for communicating with an access controller 130. The network routing logic 1200 demonstrates how an access command can be dynamically routed based on the physical proximity and network availability of a requesting device, ensuring reliable and low latency operation for the end user.

In the illustrated example, a user attempts to actuate the access controller 130 utilizing a mobile device 110. In some implementations, the user can initiate the process by tapping the mobile device 110 against an NFC tag associated with the access point, which can trigger a dedicated access control application to generate an authorization payload or an access command. Upon initiating the access command, the mobile device 110 can evaluate a condition to determine if a connection can be established via a local radio frequency (RF) interface. For example, the mobile device 110 can scan for an available BLUETOOTH or BLUETOOTH Low Energy advertisement broadcast by the access controller 130.

If the mobile device 110 determines that a local RF connection is available (following the “yes” path), the mobile device 110 can establish a secure, direct local wireless connection with the access controller 130. The access command can then be transmitted to the access controller 130 without traversing a wide area network. This local routing prioritizes speed and reduces external network bandwidth consumption, providing a seamless user experience that remains operational even during external internet service outages or wide area network congestion.

Conversely, if the mobile device 110 determines that a local RF connection is not available (following the “no” path), the network routing logic 1200 can seamlessly fall back to a remote routing path. A local RF connection may be unavailable, for example, if the user is off site, if environmental interference blocks the signal, if the local RF interface of the mobile device 110 is disabled, or if the user is attempting to remotely grant access to a guest. In this scenario, the mobile device 110 can transmit the access command over a cellular network 150. The cellular network 150 routes the command to a remote cloud server via a wide area network 172. The remote cloud server can authenticate the request against a cloud-based permission database. Once verified, the remote cloud server can forward the access command back to the access controller 130 via the wide area network 172 and the cellular network 150.

By implementing this dual path routing architecture, the system can provide a distinct technological improvement to access control reliability. This architecture can allow users to manage and actuate the access point from any location with cellular coverage via the cloud fallback path, while also providing a low latency, localized path for physical proximity interactions that bypasses the need for centralized building network infrastructure.

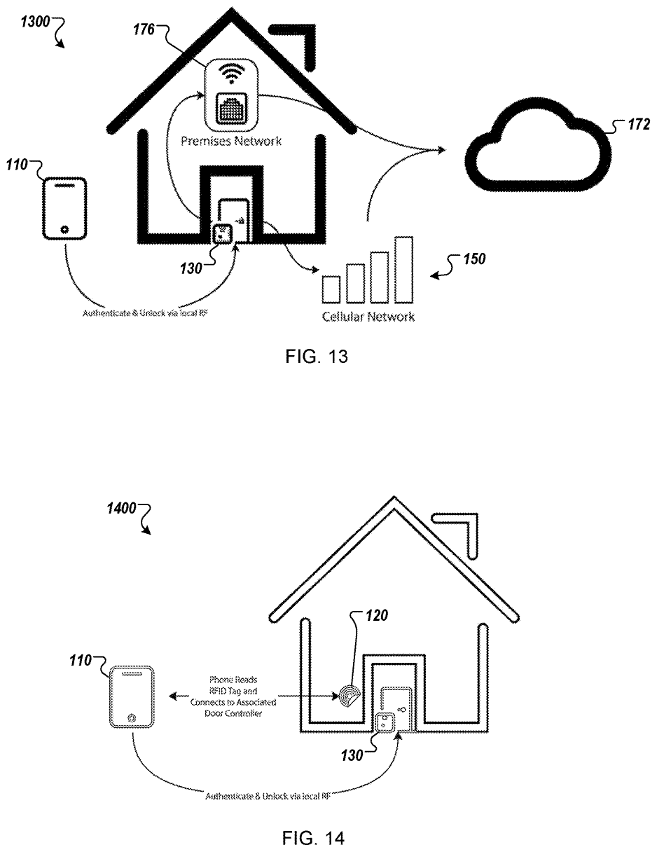

FIG. 13 is a schematic diagram illustrating an example communication architecture 1300 for an access control system. The communication architecture 1300 demonstrates the multi path connectivity capabilities of the access controller 130, which allows for seamless operation across local and wide area networks through redundant hardware interfaces.

In some implementations, a user can utilize a mobile device 110 to interact with the access controller 130. As illustrated, the mobile device 110 can be configured to authenticate and unlock the access point via a local radio frequency (RF) interface. This direct wireless interaction between the mobile device 110 and the access controller 130, which can utilize protocols such as BLUETOOTH Low Energy or Near Field Communication, represents a first communication path that facilitates high speed, proximity-based access. This path is particularly advantageous as it does not require the authentication signal to traverse external network infrastructure, thereby ensuring functionality even if both the building network and cellular networks are unavailable.

The access controller 130 can be communicably coupled to a network infrastructure 176. The network infrastructure 176 can represent a local area network (LAN) router, a wireless access point, or a localized gateway hub. This connection represents a second communication path that allows the access controller 130 to reach a wide area network 172, such as the internet or a cloud-based management environment. By utilizing the network infrastructure 176 when it is available, the system can perform high speed data synchronization and receive configuration changes while prioritizing the use of localized broadband resources over cellular data bandwidth.

To ensure high availability and resilience against localized network failures, the access controller 130 can concurrently maintain a connection to a cellular network 150. As shown in the communication architecture 1300, the access controller 130 can establish a third, redundant data path that provides out of band connectivity to the wide area network 172 via the cellular network 150. This cellular path acts as a critical failover mechanism that operates independently of the network infrastructure 176. For example, if the network infrastructure 176 experiences a hardware malfunction or if the building broadband connection to the wide area network 172 is disrupted, the access controller 130 can automatically transition the routing of management traffic and remote access commands to the cellular network 150 upon detecting a loss of connectivity through the network infrastructure 176.

This multi path communication architecture 1300 provides a distinct technological improvement over traditional systems by effectively decoupling the operational reliability of the access point from the localized stability or availability of the network infrastructure 176. By integrating local RF capabilities, network infrastructure 176 connectivity, and redundant cellular network 150 connectivity within a single unit, the system ensures that the access point remains manageable and secure regardless of the state of the local building infrastructure. This configuration allows property managers to maintain real time oversight through the wide area network 172 even during localized IT outages, providing the reliability required for secure facility management.

FIG. 14 is a schematic diagram illustrating an example interaction scenario 1400 for initiating an access request utilizing a passive tag. The interaction scenario 1400 demonstrates a streamlined user experience where the physical proximity (e.g., a physical tap) of the mobile device 110 to an access point is utilized to automate the identification and authentication process.

In some implementations, the interaction scenario 1400 involves the mobile device 110, the passive tag 120, and the access controller 130. The passive tag 120 can be a radio frequency identification (RFID) tag or a near field communication (NFC) tag mounted on a door frame or an external housing of the access controller 130. The passive tag 120 can be configured to store localized identification data, such as a unique identifier for the access controller 130, cryptographic keys, or network configuration metadata.

As illustrated, a user can bring the mobile device 110 into close physical proximity with the passive tag 120. In response to the proximity, the mobile device 110 can read the localized identification data from the passive tag 120. This reading process can trigger a background service or wake the access control application, allowing the device to process the tag data locally and immediately initiate a handshake protocol even in environments with poor cellular or building network coverage. The information retrieved from the passive tag 120 can allow a dedicated application on the mobile device 110 to automatically identify the specific access controller 130 associated with that door, thereby eliminating the need for the user to manually select the correct door from a list within a graphical user interface.

Once the mobile device 110 has identified the associated access controller 130 via the passive tag 120, the mobile device 110 can proceed to authenticate and unlock the access point via a local radio frequency (RF) interface. For example, the mobile device 110 can utilize the information from the passive tag 120 to establish a secure, encrypted BLUETOOTH Low Energy connection with the access controller 130 by using a Media Access Control (MAC) address or a service UUID extracted from the passive tag 120 to bypass a general device discovery scan, thereby reducing connection latency and power consumption. During this phase, the mobile device 110 can transmit an authorization payload to the access controller 130. The access controller 130 can then verify the authorization payload against its localized permission cache to determine if the access request should be granted.

The interaction scenario 1400 can provide a significant technological improvement in both usability and security. By utilizing the passive tag 120 as a physical trigger for the local RF connection, the system can help ensures that the user is physically present at the door before an unlock command is issued. Furthermore, this innovation can provide a highly reliable “intent to enter” signal that distinguishes an intentional access attempt from a user simply walking past the door, which can improve security over automated proximity systems that may trigger unintentional unlocks without an explicit physical interaction with a tag. This decentralized approach can allow for robust access control functionality that is independent of building network availability or centralized cloud latency.

FIG. 15 is a schematic diagram illustrating an example credential synchronization process 1500 for a distributed access control system. The credential synchronization process 1500 demonstrates how user permissions can be centrally managed and efficiently propagated to a collection of decentralized access controllers 130 deployed throughout one or more protected locations.

In some implementations, an administrator or authorized user 1510 can interface with a management application to generate, modify, or revoke access credentials. As illustrated by the “Credentials Added” communication flow, the new or updated credential data is transmitted from a computing device operated by the user 1510 to a centralized database hosted on a remote cloud server accessible via a wide area network 172. The added credentials can include cryptographic tokens, user identification profiles, specific time-based access schedules, biometric templates, or spatial zone permissions tailored to individual users or groups. The communication flow can also include credential revocation commands to immediately invalidate lost or compromised access tokens.

Upon receiving the updated credentials, the wide area network 172 can initiate a push based or pull based synchronization process to securely distribute the authorization data to all relevant edge devices within the site. As illustrated by the “Credentials Synchronized to All Devices in Site” communication flow, the system can push the updated permission sets directly to each individual access controller 130 installed at the various doors or access points of the protected location. This synchronization can occur over the multi path communication architecture detailed previously, utilizing a local network infrastructure or a redundant cellular network to ensure each access controller 130 receives the update promptly and reliably.

By synchronizing the credentials directly to the edge devices, the system ensures that each individual access controller 130 maintains a comprehensive and up to date localized permission cache. This localized cache allows each access controller 130 to autonomously verify subsequent access requests, such as the local radio frequency unlocking interactions described with reference to FIG. 14, without requiring an active connection to the wide area network 172. Because the permissions are securely stored in the localized permission cache of the access controller 130, the system can process authentication requests almost instantaneously without requiring a real time query back to the wide area network 172 at the moment the user presents a mobile device. This architecture provides a distinct technological improvement by combining the convenience and scalability of centralized cloud-based management with the speed, operational reliability, and offline resilience of decentralized edge-based authentication.

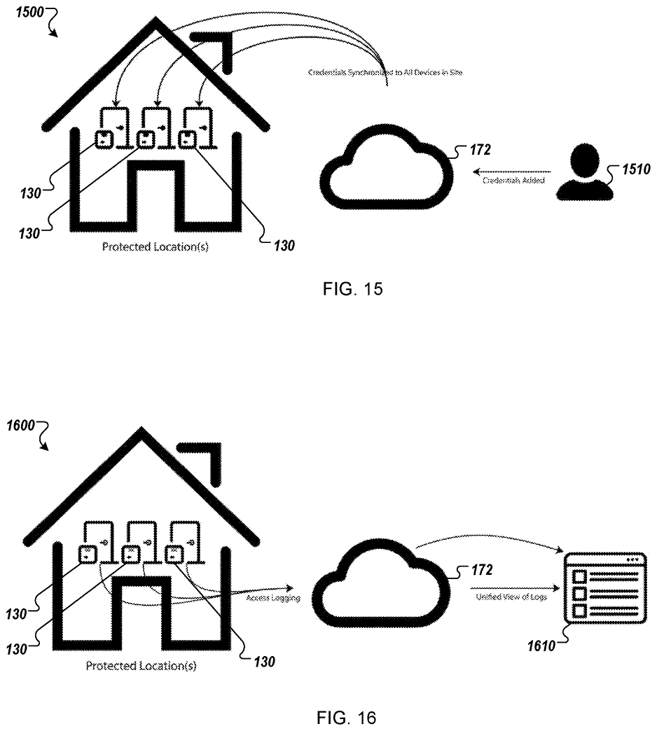

FIG. 16 is a schematic diagram illustrating an example logging architecture 1600 for a distributed access control system. The logging architecture 1600 demonstrates how decentralized event data generated at the edge can be aggregated into a centralized monitoring system, providing a comprehensive audit trail for facility management.

In some implementations, a collection of access controllers 130 can be distributed across one or more protected locations. As users interact with the various access points, each individual access controller 130 can automatically generate localized access logging data. The access logging data can include, for example, records of successful authentications, failed access attempts, hardware statuses, door prop alarms, environmental telemetry, timestamps, credential identifiers, or specific methods of entry.

As illustrated by the “Access Logging” communication flow, each access controller 130 can be configured to transmit its localized access logs to a centralized database hosted on a remote cloud server accessible via the wide area network 172. The access controllers 130 can push this data over an encrypted channel asynchronously or in near real time utilizing the multi path communication architecture described in previous figures. For example, if a local network infrastructure is congested or unavailable, an access controller 130 can securely route its access logging data through a redundant cellular network connection to ensure that critical security events are immediately reported to the wide area network 172. Furthermore, if all network connections are temporarily unavailable, the access controller 130 can buffer the access logging data in a local nonvolatile memory and automatically transmit the buffered data once a connection is reestablished.

Upon receiving the telemetry and event data from the collection of access controllers 130, a remote cloud server operating within the wide area network 172 can aggregate, format, and process the information. The aggregated data can then be routed to a management interface 1610. As illustrated by the “Unified View of Logs” communication flow, the management interface 1610 can present a consolidated dashboard to a system administrator or security personnel. The management interface 1610 can be accessed via a web browser or a dedicated mobile application, allowing administrators to filter, search, audit events, and generate compliance reports across all access controllers 130 from a single portal.

This logging architecture 1600 provides a distinct technological improvement by successfully bridging the gap between decentralized execution and centralized auditing. While the access controllers 130 perform access control decisions locally to ensure low latency and offline reliability, the logging architecture 1600 ensures that property managers still receive a comprehensive, unified view of all access activity across an entire portfolio of properties. This continuous synchronization ensures compliance and security oversight without sacrificing the performance benefits of edge-based authentication.

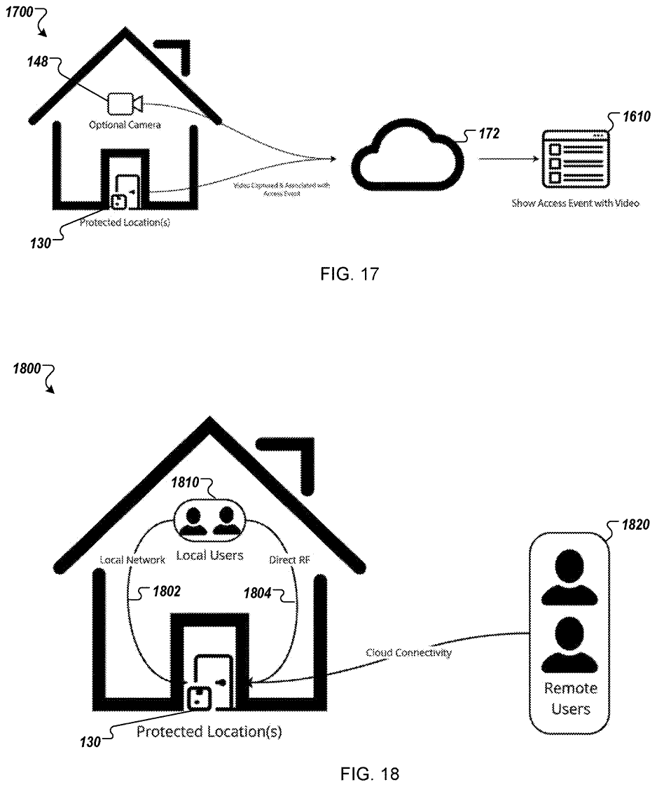

FIG. 17 is a schematic diagram illustrating an example integrated video and access logging architecture 1700 for a distributed access control system. The integrated video and access logging architecture 1700 demonstrates how visual verification can be seamlessly synchronized with edge-based access events and reliably transmitted to a centralized monitoring system even during local infrastructure failures.

In some implementations, the system can include a camera 1710 deployed within the protected location. In some implementations, the camera 1710 can be the example camera 148 of FIG. 1. In some embodiments, the camera 1710 can be a battery backed device that is communicably coupled directly to the access controller 130. In the illustrated configuration, the access controller 130 can function as a localized machine to machine access point (e.g., establishing a secure localized Wi-Fi network or a direct RF link) for the camera 1710. When a user interacts with the access controller 130, the camera 1710 can capture video footage of the interaction. The system can automatically associate this captured video with the corresponding access event log by embedding synchronized timestamps or shared event identifiers into the metadata of the video file, logging events such as an unlock success, an access denied event, or a door prop alarm.

As illustrated, the associated video and event access data are transmitted from the protected location to the wide area network 172. By routing the camera connection directly through the access controller 130, the system can leverage the multi path communication architecture of the access controller 130. For example, if a localized power outage or network failure disables the primary building internet, the battery backed camera 1710 and the battery supported access controller 130 can continue to operate. The access controller 130 can transmit the full video stream and event data over its redundant cellular connection to the wide area network 172. This advantageously eliminates the need for the camera 1710 to include a dedicated cellular modem while still ensuring uninterrupted visual and event coverage during critical environmental disruptions.

In some embodiments, the camera 1710 can be configured to execute localized instructions that automatically change the video stream resolution based on device profile metadata associated with the client requesting the video (e.g., a mobile device screen size constraint) or the currently detected network conditions (e.g., cellular bandwidth limits). This dynamic scaling can allow the camera 1710 to automatically adjust parameters such as spatial resolution, frame rate, or compression ratios to switch between transmitting high-definition video and low-definition video depending on the specific use case. For instance, if the data is being routed over a constrained cellular connection, or if the requesting client is a mobile device with a smaller screen, the camera 1710 can automatically downscale the stream to a lower resolution to conserve bandwidth and reduce latency. Conversely, if a high bandwidth local connection is available and an administrator requests a detailed view, the camera 1710 can transmit a high-definition stream.

Once received by the wide area network 172, the synchronized video and event data can be routed to the management interface 1610. As illustrated by the “Show Access Event with Video” communication flow, the management interface 1610 can present a unified, cloud-based dashboard where security personnel can view the textual access log perfectly paired with the corresponding video clip. This integrated architecture provides a significant technological improvement by ensuring high availability video auditing at the edge, dynamically adapting to network constraints, and centralizing the visual verification process for property managers.

FIG. 18 is a schematic diagram illustrating an example multiuser access architecture 1800 for a distributed access control system. The multiuser access architecture 1800 demonstrates how a single, decentralized access controller 130 can simultaneously accommodate disparate communication paths based on the physical location and network availability of the requesting users.

In some implementations, the system can support interactions from one or more local users 1810 who are physically present at or near the protected location. As illustrated, the local users 1810 can communicate with the access controller 130 utilizing a local network connection 1802 or a direct radio frequency (RF) connection 1804. The direct RF connection 1804 can utilize protocols such as BLUETOOTH Low Energy or Near Field Communication to provide immediate, proximity-based unlocking without requiring external network infrastructure. Alternatively, the local network connection 1802 can utilize the internal building Wi-Fi or a local network infrastructure (e.g., the network infrastructure 176 described previously) to securely route commands to the access controller 130. By utilizing these localized paths, the local users 1810 experience ultra-low latency authentications that remain fully operational even during external internet or cellular outages.

Concurrently, the system can support interactions from one or more remote users 1820 who are located off site or geographically distant from the protected location. The remote users 1820 can include property managers, system administrators, emergency responders, or residents attempting to remotely unlock a door for a guest. As illustrated, the remote users 1820 can interact with the access controller 130 via cloud connectivity. This cloud connectivity path routes access commands and management instructions through a wide area network 172, such as the internet, to the access controller 130. The access controller 130 can receive these remote commands via a primary broadband connection or via an integrated redundant connection to a cellular network 150.

The multiuser access architecture 1800 provides a distinct technological improvement by unifying local and remote access paradigms within a single edge computing device. Traditional systems often segregate offline standalone locks from online cloud connected locks, forcing a compromise between offline reliability and remote manageability. By contrast, the access controller 130 can dynamically bridge these paradigms. It continuously listens for direct RF and local network commands from the local users 1810 to facilitate rapid, offline entry, while simultaneously maintaining secure cloud connectivity to allow the remote users 1820 to manage credentials, view access logs, and actuate the door from anywhere in the world.

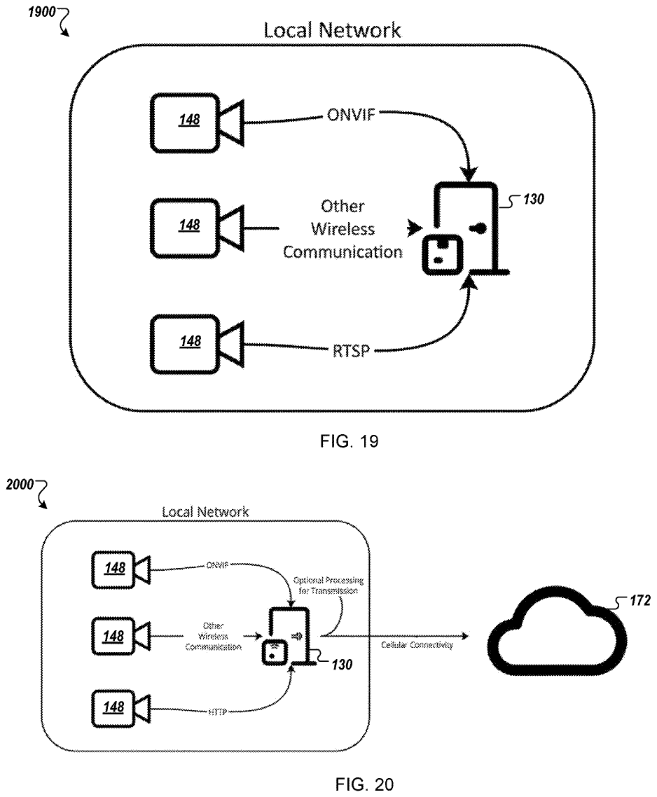

FIG. 19 is a schematic diagram illustrating an example local video integration architecture 1900 for a distributed access control system. The local video integration architecture 1900 demonstrates how an access controller 130 can act as a localized gateway to ingest, synchronize, and manage video data from multiple distributed cameras 148 within a shared local network environment.

In some implementations, the system can include one or more of the cameras 148 deployed at various vantage points around a protected location. Unlike cloud dependent architectures that require video feeds to be routed to a wide area network before being associated with access events, the cameras 148 in the local video integration architecture 1900 are configured to communicate directly with the access controller 130 over the local network. This local network can utilize the network infrastructure 176 described previously, comprising a wired local area network, a localized Wi-Fi environment, or a direct edge device mesh.

To ensure broad compatibility with various hardware vendors and legacy security infrastructure, the access controller 130 can be configured to support multiple video streaming and device management protocols. As illustrated, a first camera 148 can communicate with the access controller 130 utilizing the Open Network Video Interface Forum (ONVIF) protocol, which allows the access controller 130 to discover the camera, manage its settings (such as pan, tilt, and zoom configurations), and pull standardized event metadata (such as motion detection or line crossing alerts). A second camera 148 can communicate with the access controller 130 utilizing the Real Time Streaming Protocol (RTSP) to provide a continuous, low latency media stream directly to the access controller 130, which can securely buffer the media stream within a localized nonvolatile memory to capture pre-event and post event footage. Additionally, a third camera 148 can connect to the access controller 130 utilizing other wireless communication methods, such as localized machine to machine connections, proprietary direct radio frequency links, or localized peer to peer connections.

This local video integration architecture 1900 provides a distinct technological improvement by centralizing edge-based video processing at the access controller 130. By pulling the video feeds directly across the local network, the access controller 130 can automatically associate high-definition video clips with specific access events, such as an unlock command or a forced entry alarm, in real time. This localized processing drastically reduces wide area network bandwidth consumption, as the access controller 130 only needs to upload the relevant, event triggered video clips to the cloud rather than transmitting continuous streams. Furthermore, this architecture ensures that video verification remains fully operational and synchronized with access logs even during external internet service outages.

FIG. 20 is a schematic diagram illustrating an example edge processing and cellular transmission architecture 2000 for a distributed access control system. The architecture 2000 demonstrates how the access controller 130 can ingest local video feeds, perform edge-based processing, and reliably transmit the processed video data to a remote cloud server via a cellular network.

In some implementations, multiple cameras 148 can be deployed within a local network environment to monitor an access point. The cameras 148 can communicate directly with the access controller 130 utilizing various protocols. As illustrated, a first camera 148 can communicate utilizing the Open Network Video Interface Forum (ONVIF) protocol, a second camera 148 can communicate utilizing other wireless communication methods (such as direct radio frequency links), and a third camera 148 can communicate utilizing Hypertext Transfer Protocol (HTTP) to push image frames (e.g., JPEG snapshots) or buffered video segments directly to the access controller 130 over the local network upon detecting a motion event or receiving a trigger from the access controller 130.

Before transmitting the ingested video data to the wide area network 172, the access controller 130 can evaluate current network bandwidth conditions or device configuration profiles to perform optional processing for transmission. Because cellular connectivity can be subject to bandwidth constraints or data transmission limits, the access controller 130 can execute localized algorithms to optimize the video payload. This optional processing can include compressing the video files, transcoding the video stream to a lower bitrate, downscaling the spatial resolution (e.g., converting a high-definition video clip to a lower resolution format), extracting specific key frames corresponding to the exact moment of an access event, or encrypting the data for secure transit.

Following the optional processing, the access controller 130 can route the optimized video data and the associated access event metadata to the wide area network 172 utilizing an integrated cellular connection to a cellular network 150. This architecture 2000 provides a distinct technological improvement by allowing the access controller 130 to function as an intelligent edge gateway. By processing the video locally before transmission, the system minimizes cellular data consumption, reduces transmission latency, and optimizes edge storage resources. Furthermore, utilizing the cellular connectivity path ensures that visual verification of access events is reliably transmitted to remote administrators even when the local building broadband infrastructure is offline, congested, or otherwise unavailable.

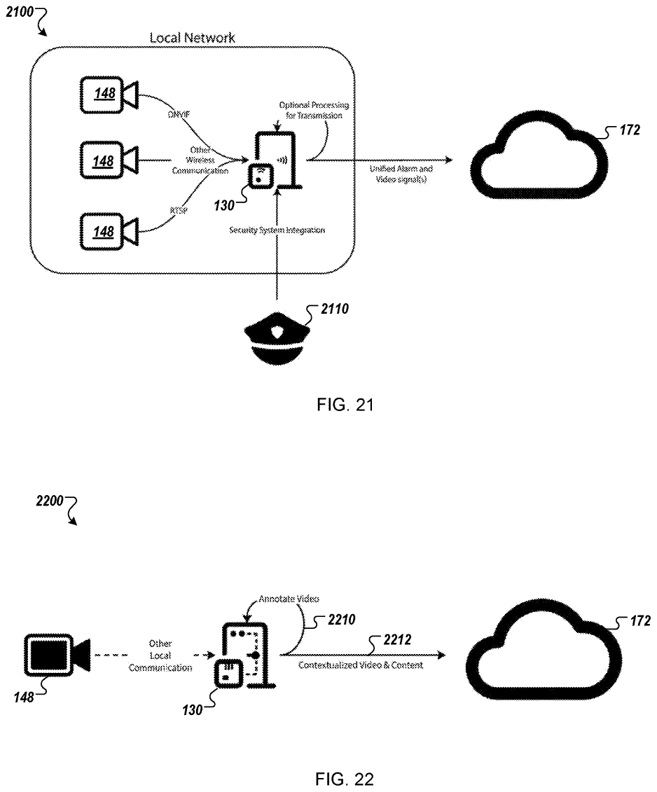

FIG. 21 is a schematic diagram illustrating an example integrated security and video architecture 2100 for a distributed access control system. The architecture 2100 demonstrates how the access controller 130 can serve as a centralized edge gateway that unifies video data from multiple cameras 148 with signals from an external security system integration 2110.

In some implementations, multiple cameras 148 are deployed within a local network to provide visual coverage of a protected location. As illustrated, the access controller 130 is configured to ingest video streams using various protocols, including but not limited to the Open Network Video Interface Forum (ONVIF) protocol, the Real Time Streaming Protocol (RTSP), and other wireless communication methods such as proprietary radio frequency links. This multi-protocol ingestion allows the access controller 130 to maintain compatibility with a diverse array of localized video hardware while performing real time synchronization of video frames with localized access events.

The architecture 2100 further includes a security system integration 2110. The security system integration 2110 can represent a connection to a third-party intrusion detection system, a fire alarm control panel, or a direct interface with law enforcement and/or a security monitoring authority. By integrating with the security system integration 2110, the access controller 130 can receive external alarm triggers, such as a glass break sensor activation or a manual panic button press. In response to these external triggers, the access controller 130 can automatically tag the relevant video feeds from the cameras 148 to ensure that the visual data corresponding to the alarm event is prioritized for review.

Before transmitting data to the wide area network 172, the access controller 130 can perform optional processing for transmission. This processing can involve the edge-based optimization techniques described previously, such as transcoding, compression, or the extraction of specific key frames. The access controller 130 then generates a unified alarm and video signal. This unified signal represents a combined data package that contains both the textual or binary alarm event data and the associated synchronized video clips or snapshots.

As illustrated, the unified alarm and video signal is transmitted from the access controller 130 to the wide area network 172. This architecture 2100 provides a distinct technological improvement by eliminating the “siloed” nature of traditional security systems where video and alarms are managed through separate, uncoordinated channels. By unifying these signals at the edge within the access controller 130, the system ensures that when an alarm reaches a remote cloud server or a management interface, it is already pre enriched with the relevant visual evidence. This integration significantly improves the speed and accuracy of remote event verification, reduces the incidence of false alarms, and optimizes network bandwidth by only transmitting high resolution video when a verified security trigger from the security system integration 2110 is detected.

FIG. 22 is a schematic diagram illustrating an example video annotation and contextualization architecture 2200 for a distributed access control system. The architecture 2200 demonstrates how an access controller 130 can act as an intelligent processing node that enriches raw video feeds with localized event data to produce contextualized content for remote monitoring.

In some implementations, a camera 148 is positioned to monitor an access point and is communicably coupled to the access controller 130. As illustrated, the camera 148 can transmit video data to the access controller 130 utilizing other local communication methods, such as an encrypted wired Ethernet connection, a Power over Ethernet (PoE) link, a localized Wi-Fi mesh network, or a low power wide area network (LPWAN) protocol. These communication methods can include an encrypted wired local area network connection, a secured localized Wi-Fi link, or a direct machine to machine wireless protocol. This localized connection allows the access controller 130 to ingest video frames in real time as events occur at the physical doorway.

Upon receiving the video data, the access controller 130 can perform a video annotation process 2210. During this process, the access controller 130 can leverage its internal logic and credential database to associate specific access control metadata directly with the video stream. For example, if an access event occurs, the access controller 130 can annotate the corresponding video clip with the user name, a unique mobile device identifier, a specific credential type (e.g., NFC, BLUETOOTH, or biometric), the specific credential identifier, the precise timestamp, the status of the door sensors, or specific alarm triggers such as a forced entry alert or an unauthorized credential attempt. This annotation can be performed by embedding the data into the metadata of the video file, applying a visual overlay directly onto the video frames, or generating a cryptographic digital signature (e.g., utilizing a hash based message authentication code) to verify the authenticity and to ensure the integrity of the contextualized content for auditing or evidentiary purposes.

As illustrated, the resulting contextualized video and content 2212 are transmitted from the access controller 130 to the wide area network 172 utilizing the multi path communication architecture described previously, such as via a primary broadband link or a redundant cellular connection. Because the video has been pre-annotated at the edge, the wide area network 172 receives a self-contained data package (e.g., a standardized media container format such as MP4 or Matroska, enriched with custom metadata headers) of information. This architecture 2200 can provide a distinct technological improvement over systems that store video and access logs in separate, unlinked databases. By contextualizing the video at the edge, the system eliminates the need for complex and resource intensive post processing or manual correlation at the cloud level. This can help ensure that when a property manager views the video via the management interface 1610, the relevant security context can be immediately available, facilitating faster incident response and more efficient auditing of access events across an entire site portfolio, thereby enabling centralized security operations centers to conduct forensic analysis with immediate access to all relevant event context.

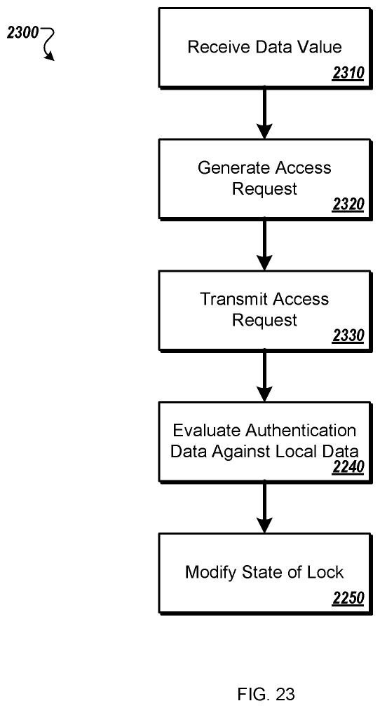

FIG. 23 is a flowchart illustrating an example process 2300 for decentralized access control. The process 2300 demonstrates the sequence of operations between a user device, a localized identification tag, and an edge-based access controller to facilitate a secure, offline authentication process.

At 2310, the process 2300 can include receiving a data value. In some implementations, a mobile device can receive a localized data value by reading or scanning a passive tag positioned proximate to an access controller at a secure access point (e.g., via an NFC tap or RFID scan). The passive tag can be a near field communication tag or a radio frequency identification tag, and the data value can include a unique hardware identifier or network configuration parameters corresponding to the specific access controller. For example, as described with reference to the access control system 100 in FIG. 1, a user can bring a mobile device 110 into close physical proximity with a passive tag 120 mounted on a door frame to seamlessly and securely read the localized identification data without requiring a cellular network connection.

At 2320, the process 2300 can include generating an access request that includes authentication data. Upon receiving the data value, the mobile device can execute a local application to generate the access request. Generating the access request can include prompting a local biometric authentication on the mobile device and subsequently cryptographically signing a payload that incorporates the received data value, a user identification credential, and a timestamp. For example, the access request can be generated using a dedicated access control application, such as the application executing in the memory 204 of the mobile device 110 described with reference to FIG. 2, which can automatically identify the specific access point based on the tapped tag and bypass the need for a user to manually select the correct door from a graphical user interface.

At 2330, the process 2300 can include transmitting the access request via a local wireless network connection to a controller associated with an access point. In some implementations, the mobile device can transmit the generated access request directly to the access controller utilizing a local radio frequency connection. By establishing a direct BLUETOOTH Low Energy connection with the access controller utilizing the data value, the mobile device allows the access request to be transmitted securely without routing data through a centralized wide area network or a building local area network. For example, this local transmission can utilize the local wireless connection between the mobile device 110 and the access controller 130 described with reference to FIG. 1, ensuring high speed, proximity-based access that remains functional even if both the building internet and cellular networks are experiencing outages.

At 2240, the process 2300 can include evaluating authentication data against locally stored data. In some implementations, the access controller can receive the transmitted access request via its local wireless interface and extract the authentication data. The access controller can then evaluate the extracted authentication data against a localized permission cache stored within a nonvolatile memory of the access controller. This edge-based evaluation allows the access controller to autonomously determine if the user has authorization for that specific door at that specific time, without requiring a real time cloud query. If the evaluation determines the user lacks authorization, the access controller can generate an access denied event and refrain from modifying the lock state. For example, the evaluation can be performed by a processing unit of the edge device, such as the processor 412 of the access controller 130 described with reference to FIG. 4, which queries a decentralized permission cache stored within its local memory 410.

At 2250, the process 2300 can include modifying a state of a lock of the access point based on the evaluation. In response to a successful evaluation of the authentication data against the local data, the access controller can actuate a physical change at the access point (e.g., energizing a strike plate, disengaging a magnetic lock, or driving a motorized deadbolt to transition between a locked and unlocked state). In practice, the access controller can energize a local relay or transmit a Wiegand protocol signal to modify the state of the lock from a secured state to an unsecured state, thereby granting the user physical entry to the protected location. For example, modifying the state of the lock can include the access controller 130 transmitting an electrical signal via the access point interface 416 to physically actuate the lock 140, as described with reference to FIG. 1 and FIG. 4.

In some implementations, the process 2300 can further include determining, by the mobile device, that the local wireless network connection to the controller has failed, and transmitting, by the mobile device over a cellular network, a fallback access request to a remote cloud server to authenticate the mobile device. Upon receiving the fallback request, the process 2300 can further include authenticating, by the remote cloud server, the fallback access request; transmitting, by the remote cloud server, an unlock command to the controller via a cellular transceiver of the controller; and modifying, by the controller, the state of the lock based on receiving the unlock command. For example, if an initial local RF connection attempt is unavailable or blocked by interference, the mobile device 110 can seamlessly shift to a remote routing path by passing the fallback access request through the wide area network 172 to the remote system 170, as described with reference to FIG. 1, which can subsequently authenticate and actuate the lock 140 via a redundant connection to the cellular network 150.

In some implementations, the process 2300 can further include powering the controller via a Power over Ethernet connection and transitioning the controller to draw power from a Universal Serial Bus Type C power source in response to detecting a disruption in the Power over Ethernet connection. For example, this failover mechanism reflects the operation of the power interface 418 detailed with reference to FIG. 4, where the access controller 130 automatically manages diverse power inputs and transitions from a primary power source to a secondary, localized battery source to sustain lock actuation and network communication during a building-wide power blackout.

In some implementations, the process 2300 can further include capturing, by a camera in communication with the controller, image data of a user attempting to access the access point. The process 2300 can further include compressing, by the controller, the image data, and transmitting, by a cellular transceiver of the controller, an access log comprising the compressed image data to a remote cloud server. For example, the access controller 130 can receive the raw video frames from the locally connected camera 148, execute localized algorithms to optimize the video payload, and route the unified data over the cellular network 150 to the remote system 170 for cloud-based auditing, as introduced in FIG. 1.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments may also be implemented in combination in a single embodiment in part or in whole. Conversely, various features that are described in the context of a single embodiment may also be implemented in multiple embodiments separately or in any suitable subcombination. Moreover, although features may be described herein as acting in certain combinations and/or initially claimed as such, one or more features from a claimed combination may in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. An access control system, comprising:
a near field communication (NFC) tag configured to wirelessly provide a data value;
an access point comprising a lock and a mechanism to control a state of the lock;
a controller for the access point that is configured to transmit instructions to the access point to change the state of the lock, wherein the controller further includes a first local wireless network interface and a first data repository, wherein the first data repository is configured to locally store authentication data for authorized users; and
a mobile device that includes an NFC reader, a second local wireless network interface, and a second data repository that stores authentication data for a corresponding user, wherein the mobile device is configured to:
receive, using the NFC reader, the data value from the NFC tag;
interpret the data value received from the NFC tag;
generate, based on the interpretation of the data value, a wireless access request, wherein the wireless access request includes the controller as a recipient and the authentication data; and
transmit, using the second local wireless network interface, the wireless access request to the controller over a local wireless network connection with the controller;
wherein the controller is configured to evaluate the authentication data received in the wireless access request received from the mobile device against the locally stored authentication data and, based on the evaluation, to send a control signal to the access point to modify a state of the lock.

2. The access control system of claim 1, wherein the mobile device further comprises a cellular transceiver, and wherein the mobile device is further configured to:
determine that the transmission of the wireless access request to the controller over the local wireless network connection has failed; and
transmit, using the cellular transceiver, a fallback access request to a remote cloud server over a cellular network.

3. The access control system of claim 2, wherein the controller further comprises a controller cellular transceiver, and wherein the controller is configured to receive an unlock command from the remote cloud server via the controller cellular transceiver based on an authentication of the fallback access request by the remote cloud server.

4. The access control system of claim 3, wherein the controller cellular transceiver is configured to communicate using a Long-Term Evolution M (LTE-M) protocol.

5. The access control system of claim 1, wherein the controller further comprises a power interface configured to receive electrical power from at least one of a Power over Ethernet (PoE) connection or a Universal Serial Bus Type-C (USB-C) connection.

6. The access control system of claim 5, wherein the controller is configured to utilize the USB-C connection as a backup power source in response to a power failure of the PoE connection.

7. The access control system of claim 1, wherein the locally stored authentication data of the controller comprises a cached subset of global authentication data, wherein the cached subset corresponds to authorized users who have recently accessed the access point.

8. The access control system of claim 7, wherein the controller is further configured to:
determine that the authentication data received in the wireless access request from the mobile device is absent from the cached subset; and
in response to determining the authentication data is absent, transmit a verification request to a remote cloud server to authenticate the mobile device against a global data repository of authorized user credentials.

9. The access control system of claim 8, wherein the controller is further configured to update the cached subset of global authentication data stored in the data repository based on an authentication response received from the remote cloud server.

10. The access control system of claim 1, further comprising a camera in communication with the controller, wherein the controller is configured to cause the camera to capture image data of a user associated with the mobile device in response to receiving the wireless access request.

11. The access control system of claim 10, wherein the controller is configured to perform biometric facial recognition on the captured image data, and wherein the control signal to modify the state of the lock is further conditioned upon the biometric facial recognition matching an authorized user profile associated with the authentication data.

12. The access control system of claim 10, wherein the controller further comprises a cellular transceiver, and wherein the controller is configured to:
format the captured image data for transmission over a cellular network; and
transmit an access log comprising the formatted image data to a remote cloud server via the cellular transceiver.

13. The access control system of claim 1, wherein the local wireless network interface of the controller and the local wireless network interface of the mobile device are configured to communicate using a Bluetooth Low Energy (BLE) protocol.

14. The access control system of claim 1, wherein the controller further comprises an application programming interface (API) configured to synchronize an intrusion signal with captured video data and transmit a unified event record to a remote security monitoring system.

15. The access control system of claim 1, wherein the controller is configured to operate in a stand-alone configuration independently of a local area network (LAN) associated with the access point.

16. A method for controlling access to a secure location, comprising:
receiving, by a mobile device from a near field communication (NFC) tag, a data value;
generating, by the mobile device based on the data value, a wireless access request comprising authentication data;
transmitting, by the mobile device over a local wireless network connection, the wireless access request to a controller associated with an access point;
evaluating, by the controller, the authentication data against locally stored authentication data; and
modifying, by the controller, a state of a lock of the access point based on the evaluation.

17. The method of claim 16, further comprising:
determining, by the mobile device, that the local wireless network connection to the controller has failed; and
transmitting, by the mobile device over a cellular network, a fallback access request to a remote cloud server to authenticate the mobile device.

18. The method of claim 17, further comprising:
authenticating, by the remote cloud server, the fallback access request;
transmitting, by the remote cloud server, an unlock command to the controller via a cellular transceiver of the controller; and
modifying, by the controller, the state of the lock based on receiving the unlock command.

19. The method of claim 16, further comprising:
powering the controller via a Power over Ethernet (PoE) connection; and
transitioning the controller to draw power from a USB-C power source in response to detecting a disruption in the PoE connection.

20. The method of claim 16, further comprising:
capturing, by a camera in communication with the controller, image data of a user attempting to access the access point;
compressing, by the controller, the image data; and
transmitting, by a cellular transceiver of the controller, an access log comprising the compressed image data to a remote cloud server.
